(19) United States
(12) Patent Application Publication
(10) Pub. No.: US 2026/0284920 A1
(43) Pub. Date: Sep. 24, 2026

(54) SYSTEMS AND METHODS FOR CUTTING FOOD ARTICLES AND FILLING CONTAINERS THEREWITH

(71) Applicant: Solbern Inc., Fairfield, NJ (US)

(72) Inventors: Thomas Berger, Ridgefield, NJ (US); Robert Wall, Mahwah, NJ (US); Charles Davis, Roselle Park, NJ (US)

(73) Assignee: Solbern Inc., Fairfield, NJ (US)

(21) Appl. No.: 19/086,260

(22) Filed: Mar. 21, 2025

(51) Int. Cl. B26D 7/06; B26D 7/00; B26D 7/18

(52) U.S. Cl. CPC B26D 7/0608; B26D 7/0641; B26D 7/18; B26D 2007/0018; B26D 2210/02

(57) ABSTRACT

A food article cutting and container filling system includes a food article cutting subassembly, plunger, and container holder. The cutting subassembly includes a cutting blade and a body that receives a food article. The cutting subassembly is rotatable between a first position in which it receives a food article and a second position in which the received food article is cut. The plunger is movable between a retracted position in which it does not extend into the body of the cutting subassembly, and an extended position in which it extends into the body of the cutting subassembly, pushes the food article contained therein across the cutting blade causing it to be cut into a plurality of pieces, and pushes the plurality of pieces out from the cutting subassembly. The container holder is configured to receive a container and positions the container so as to receive the plurality of pieces.

### TECHNICAL FIELD

The present disclosure relates generally to systems and methods for cutting food articles and filling containers with the cut food articles and, in particular, a food article cutting and container filling system that includes a plurality of subassemblies allowing for increased capabilities, functionality, efficiency, and duty cycle.

### BACKGROUND

In general, cucumbers to be used as pickles are cut into longitudinal “spears” or “slabs” and then stored in containers. A “spear” is a longitudinally cut piece having a generally triangular cross-section, while a “slab” is an elongated sectional slice. A number of methods and equipment have been developed to improve the process of creating and packing “spears” and “slabs,” including U.S. Pat. No. 3,468,098 to Eisenberg entitled “Spear Packing Apparatus,” U.S. Pat. No. 3,662,518 to Eisenberg entitled “Spear Packing Apparatus,” U.S. Pat. No. 6,041,577 to Walz, et al. entitled “Method And Apparatus For Slicing Elongated Food Articles Into Slabs And Transferring The Slabs To Containers,” and U.S. Pat. No. 11,383,867 to Berger, et al. entitled “Spear Center Filler Apparatus,” the entire contents of each of which is incorporated herein by reference in their entirety.

However, prior art systems and methods generally have limitations associated therewith that can reduce the capabilities, functionality, efficiency, and duty cycle thereof. For example, in some prior art systems, after filling a container the system must wait until the filled container is ejected before a new empty container can be provided and cutting operations resumed, which increases the system downtime thus reducing the overall efficiency and duty cycle. Additionally, some prior art systems have plungers and cutters that are maintained permanently in alignment, which can limit the overall construction, configuration, and size of the system.

Accordingly, a need remains for systems and methods for cutting food articles and filling containers with the cut food articles that address the foregoing and other needs.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

The present disclosure relates to food article cutting and container filling systems and methods.

In accordance with aspects of the present disclosure, a food article cutting and container filling system is provided. The system includes a food article cutting subassembly, a plunger, and a container holder. The food article cutting subassembly includes a cutting blade and a body that is configured to receive a food article. The food article cutting subassembly is rotatable between a first position in which it receives a food article and a second position in which the received food article is cut. The plunger is movable between a retracted position and an extended position. When in the retracted position, the plunger does not extend into the body of the food article cutting subassembly. When in the extended position, the plunger extends into the body of the food article cutting subassembly, pushes the food article contained therein across the cutting blade causing the food article to be cut into a plurality of pieces, and pushes the plurality of pieces out from the food article cutting subassembly. The container holder is configured to receive a container and positions the container so as to receive the plurality of pieces from the food article cutting subassembly.

In some aspects, the food article cutting subassembly can be oriented at a first angle with respect to a horizontal plane when in the first position and oriented at a second angle with respect to the horizontal plane when in the second position. In such aspects, the first angle can be greater than the second angle. In other aspects, the food article cutting assembly can be rotatable about a horizontal axis between the first position and the second position.

In some other aspects, the system can include a chute that can be configured to receive a food article and transfer the food article to the food article cutting subassembly. The food article cutting subassembly can be axially aligned with the chute when it is in the first position and axially aligned with the plunger when it is in the second position.

In still other aspects, the plunger can be oriented at a first angle with respect to a horizontal plane, the food article cutting subassembly can be oriented at the first angle when in the second position, and the container holder can hold the container at a second angle with respect to the horizontal plane, such that the second angle is greater than the first angle. In such aspects, the container holder can be rotatable between a first position in which it holds the container substantially vertically and a second position in which it holds the container at the second angle.

In some aspects, the container holder can include a first receptacle and a second receptacle, and each of the first and second receptacles can be configured to receive a container. In such aspects, the container holder can be laterally movable between a first position in which the first receptacle is positioned adjacent the food article cutting subassembly and a second position in which the second receptacle is positioned adjacent the food article cutting subassembly. Additionally, the container holder can move from the first position to the second position when a container held within the first receptacle is full. Further, the container holder can receive a container in the second receptacle when in the second position and while the full container held within the first receptacle is being ejected from the first receptacle.

In some other aspects, the system can include a container lift and ejection mechanism that is rotatable in a first direction and a second direction opposite the first direction. In such aspects, when rotated in the first direction the container lift and ejection mechanism can lift a container held by the container holder, and when rotated in the second direction the container lift and ejection mechanism can lower the container and push the container held by the container holder out from the container holder.

In still other aspects, the system can include a container lift/transfer subassembly having a container transfer sled that can be configured to hold at least one container. The container lift/transfer subassembly can be vertically movable while the container transfer sled can be horizontally movable and configured to transfer a container from a first location to the container holder. In such aspects, the container transfer sled can include a centering device and a hook. The centering device can be configured to be inserted into and position a container, while the hook can be configured to grasp the container.

In accordance with aspects of the present disclosure, a food article cutting and container filling system is provided. The system includes a food article cutting subassembly, a plunger, a container lift/transfer subassembly, and a container holder. The food article cutting subassembly includes a cutting blade and a body configured to receive a food article. The plunger is movable between a retracted position and an extended position. When in the retracted position, the plunger does not extend into the body of the food article cutting subassembly. When in the extended position, the plunger extends into the body of the food article cutting subassembly, pushes the food article contained therein across the cutting blade causing the food article to be cut into a plurality of pieces, and pushes the plurality of pieces out from the food article cutting subassembly. The container lift/transfer subassembly is vertically movable and includes a container transfer sled, which is horizontally movable. The container holder is configured to receive a container from the container lift/transfer subassembly and position the container so as to receive the plurality of pieces from the food article cutting subassembly. The container transfer sled picks up the container from a first location and transfers the container from the first location to the container holder by moving horizontally.

In some aspects, (a) the container lift/transfer subassembly can move vertically between a first lowered position and a second raised position, (b) the container transfer sled can move horizontally between a first forward position and a second rearward position, (c) the container transfer sled can pick up the container from the first location when the container lift/transfer subassembly is in the first lowered position and the container transfer sled is in the first forward position, (d) the container transfer sled can transfer the container from the first location to the container holder by transitioning from the first forward position to the second rearward position, and (e) the container transfer sled can deposit the container on the container holder when the container lift/transfer subassembly is in the first lowered position and the container transfer sled is in the second rearward position.

In other aspects, the container transfer sled can include a centering device and a hook. The centering device can be configured to be inserted into and position a container, while the hook can be configured to grasp the container. In such aspects, the hook can be rotatable between a first position in which it does not grasp the container and a second position in which it grasps the container.

In still other aspects, the container lift/transfer subassembly can include a rail and the container transfer sled can be slidably mounted to the rail such that the container transfer sled is horizontally movable along the rail. In such aspects, the system can include means for moving the container transfer sled horizontally, which can be mounted to the container lift/transfer subassembly and engaged with the container transfer sled.

In some other aspects, the system can include means for moving the container transfer sled horizontally, which can be mounted to the container lift/transfer subassembly and engaged with the container transfer sled.

In some aspects, the system can include a pinion gear engaged with the container lift/transfer subassembly by a rotatable shaft and a rack mounted to a frame. The pinion gear can engage the rack and move vertically along the rack to assist in moving the container lift/transfer subassembly vertically.

In other aspects, the food article cutting subassembly can be rotatable about a horizontal axis between a first position in which it receives a food article and a second position in which the received food article is cut.

In some other aspects, the plunger can be oriented at a first angle with respect to a horizontal plane, the food article cutting subassembly can be oriented at the first angle when in the second position, and the container holder can hold the container at a second angle with respect to the horizontal plane, which can be greater than the first angle. In such aspects, the container holder can be rotatable between a first position in which it holds the container substantially vertically and a second position in which it holds the container at the second angle.

In still other aspects, the container holder can include a first receptacle and a second receptacle, and each of the first and second receptacles can be configured to receive a container. In such aspects, the container holder can be laterally movable between a first position in which the first receptacle is positioned adjacent the food article cutting subassembly and a second position in which the second receptacle is positioned adjacent the food article cutting subassembly.

In some aspects, the system can include a container lift and ejection mechanism that can be rotatable in a first direction and a second direction opposite the first direction. When rotated in the first direction, the container lift and ejection mechanism can lift a container held by the container holder, and when rotated in the second direction, the container lift and ejection mechanism can lower the container and push the container held by the container holder out from the container holder.

In accordance with aspects of the present disclosure, a food article cutting and container filling system is provided. The system includes a food article cutting subassembly, a plunger, a container holder, and a container lift and ejection mechanism. The food article cutting subassembly includes a cutting blade and a body configured to receive a food article. The plunger is movable between a retracted position and an extended position. When in the retracted position, the plunger does not extend into the body of the food article cutting subassembly. When in the extended position, the plunger extends into the body of the food article cutting subassembly, pushes the food article contained therein across the cutting blade causing the food article to be cut into a plurality of pieces, and pushes the plurality of pieces out from the food article cutting subassembly. The container holder is configured to receive a container from the container lift/transfer subassembly and position the container so as to receive the plurality of pieces from the food article cutting subassembly. The container lift and ejection mechanism is movable to lift a container held by the container holder, lower the container held by the container holder, and push the container held by the container holder out from the container holder.

In some aspects, the container lift and ejection mechanism can be rotatable in a first direction and a second direction opposite the first direction. In such aspects, when the container lift and ejection mechanism is rotated in the first direction it can lift the container held by the container holder, and when it is rotated in the second direction it can lower the container and push the container held by the container holder out from the container holder.

In other aspects, the container holder can include a bottom platform on which the container rests, and the bottom platform can include a gap through which the container lift and ejection mechanism extends to lift the container. In such aspects, the container holder can include a first receptacle and a second receptacle, each of the first and second receptacles being configured to receive a container. Additionally, in such aspects, the system can include a second container lift and ejection mechanism, such that each of the container lift and ejection mechanisms is associated with one of the first and second receptacles. The container holder can also be laterally movable between a first position in which the first receptacle is positioned adjacent the food article cutting subassembly and a second position in which the second receptacle is positioned adjacent the food article cutting subassembly.

In some other aspects, the plunger can be oriented at a first angle with respect to a horizontal plane, the food article cutting subassembly can be oriented at the first angle when in the second position, and the container holder can hold the container at a second angle with respect to the horizontal plane, which can be greater than the first angle. In such aspects, the container holder can be rotatable between a first position in which it holds the container substantially vertically and a second position in which it holds the container at the second angle. In other such aspects, the container lift and ejection mechanism can lift the container upon rotation of the container holder from the first position to the second position and push the container out from the container holder upon rotation of the container holder from the second position to the first position.

In still other aspects, the system can include a container lift/transfer subassembly having a container transfer sled that is configured to hold at least one container. The container lift/transfer subassembly can be vertically movable while the container transfer sled can be horizontally movable and configured to transfer a container from a first location to the container holder. In such aspects, the container transfer sled can include a centering device and a hook. The centering device can be configured to be inserted into and position a container, and the hook can be configured to grasp the container.

In some other aspects, the food article cutting subassembly can be rotatable about a horizontal axis between a first position in which it receives a food article and a second position in which the received food article is cut.

Other features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the present disclosure will be apparent from the following Detailed Description of the Invention, taken in connection with the accompanying drawings, in which:

FIG. 1 is an isometric view of an exemplary food article cutting and container filling system of the present disclosure;

FIG. 2 is a partial front perspective view of the food article cutting and container filling system of FIG. 1 showing four cutting and container filling units thereof in greater detail;

FIG. 3 is an enlarged view of Section 3-3 of FIG. 2;

FIG. 4 is a top front perspective view of a portion of the food article cutting and container filling system of FIG. 1 showing two cutting and container filling units thereof in greater detail;

FIG. 5 is a partial side perspective view illustrating a single food article cutting subassembly and plunger of the food article cutting and container filling system of FIG. 1;

FIGS. 6A-6C are detailed views illustrating a container lift/transfer subassembly of the food article cutting and container filling system of FIG. 1 in different positions;

FIGS. 7A-7C are detailed views illustrating a container holder subassembly of the food article cutting and container filling system of FIG. 1 in different positions;

FIGS. 8A-8D are detailed views illustrating container lift and ejection mechanisms of the food article cutting and container filling system of FIG. 1 in different positions;

FIGS. 9A and 9B are partial side perspective views illustrating a single food article cutting subassembly and plunger of the food article cutting and container filling system of FIG. 1 in different positions;

FIG. 9C is a detailed view of cutting blades and a container release mechanism of the cutting unit of FIGS. 9A and 9B;

FIG. 10 is a schematic diagram illustrating an exemplary angular orientation of the food article cutting subassembly, the plunger, the container holder subassembly, and a container of the food article cutting and container filling system of FIG. 1; and

FIGS. 11A-11K are partial front perspective snapshots of the food article cutting and container filling system of FIG. 1 at sequential points in time illustrating the position of various components thereof during different stages of operation of the food article cutting and container filling system.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

It should be understood that the relative terminology used herein, such as “front,” “rear,” “left,” “top,” “bottom,” “vertical,” and “horizontal” is solely for the purposes of clarity and designation and is not intended to limit the invention to embodiments having a particular position and/or orientation. Accordingly, such relative terminology should not be construed to limit the scope of the present invention. In addition, it should be understood that the invention is not limited to embodiments having specific dimensions. Thus, any dimensions provided herein are merely for an exemplary purpose and are not intended to limit the invention to embodiments having particular dimensions.

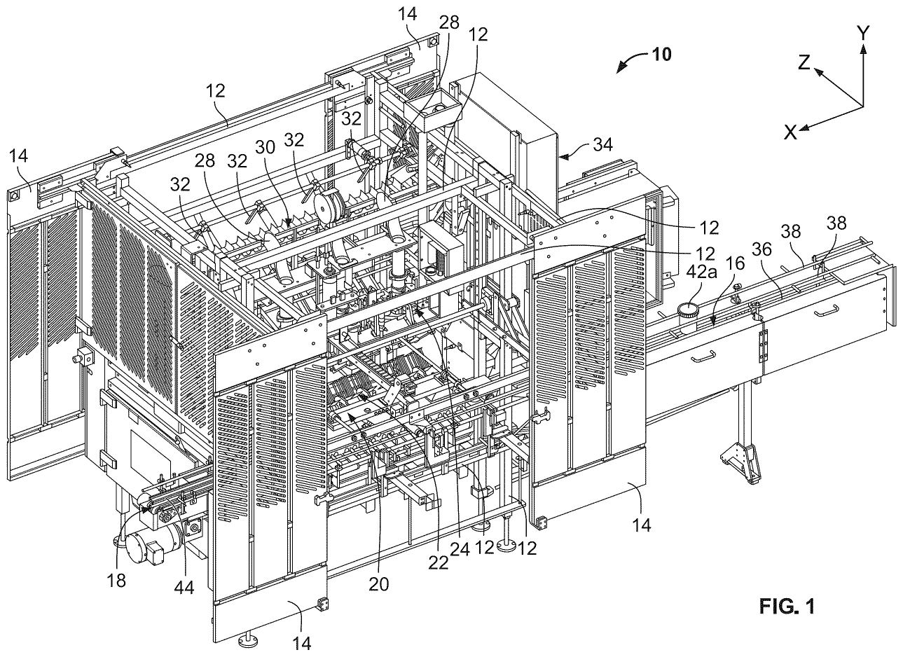

The present disclosure relates to systems and methods for cutting food articles and filling containers with the cut food articles, as described in detail below in connection with FIGS. 1-11K. It should be understood that the elongated food articles referenced herein can be any elongated food article that is cut into sections, spears, slabs, etc. In particular, the term elongated food articles as used herein should be understood to reference, but not be limited to, cucumbers and may be referred to as such herein.

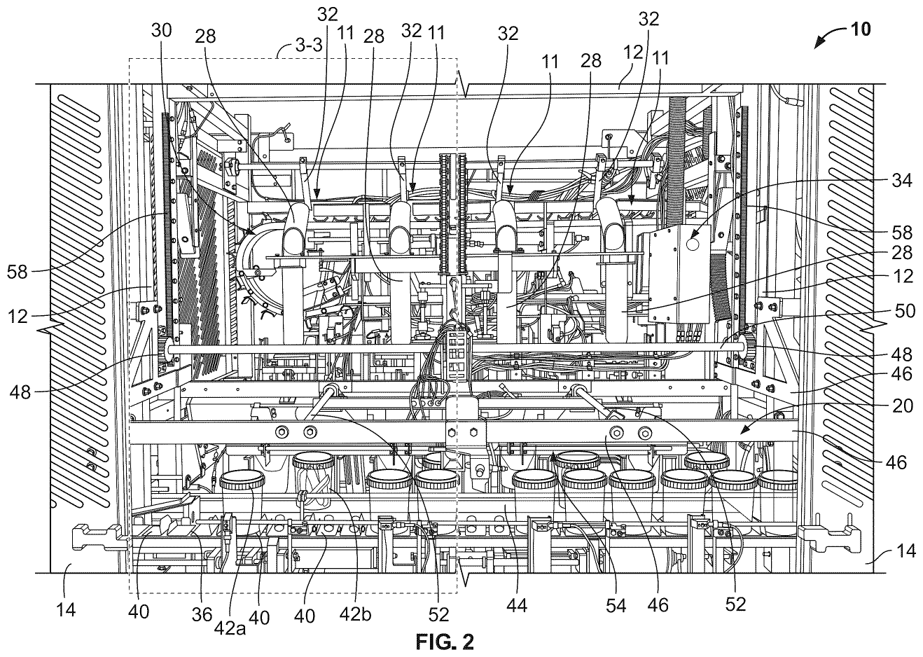

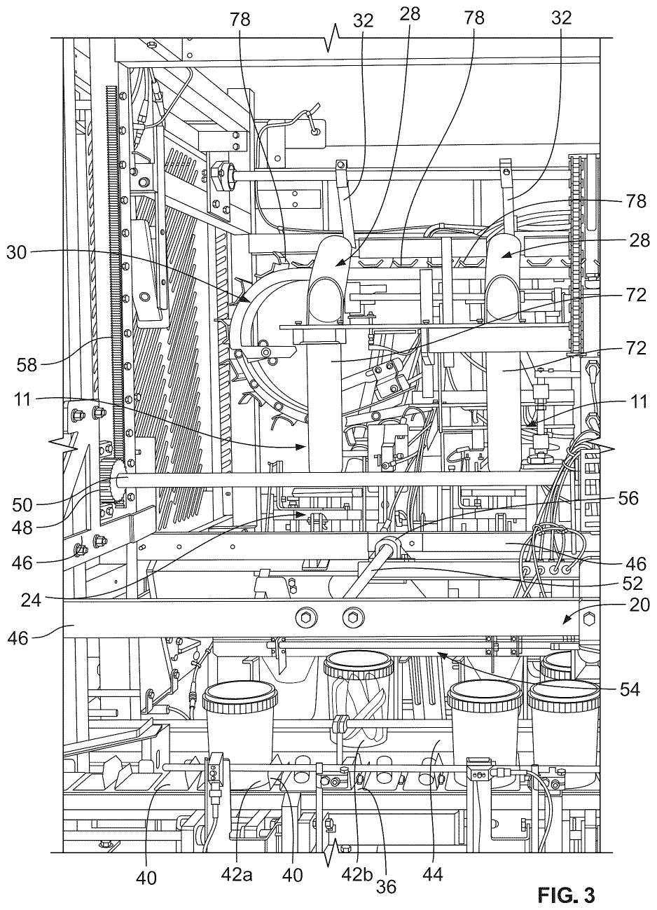

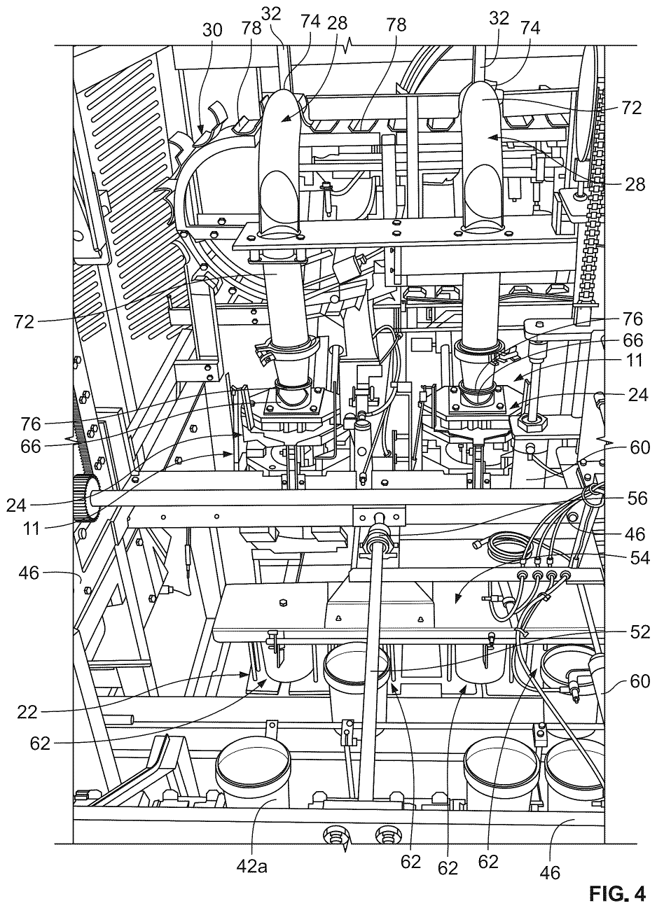

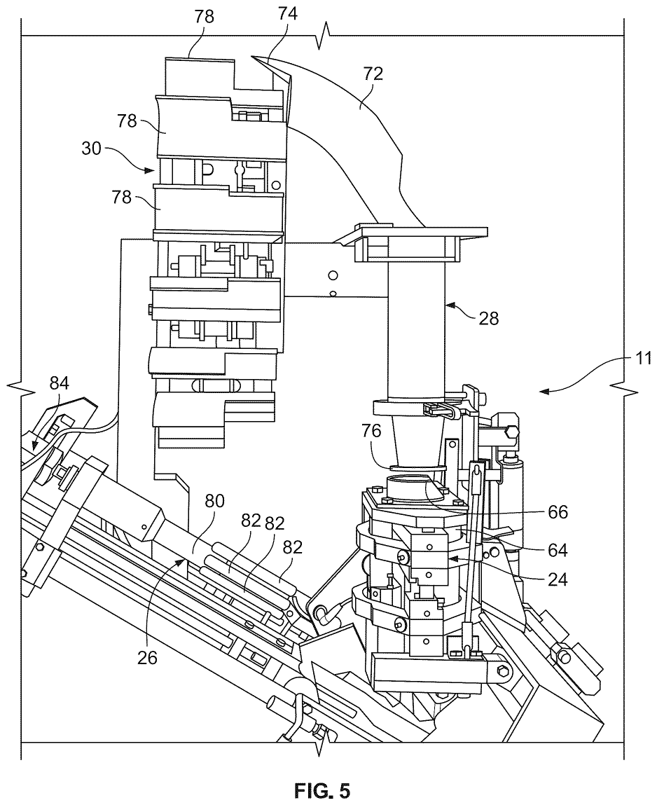

With reference to FIGS. 1-5, an exemplary food article cutting and container filling system 10 (hereinafter “system”) of the present disclosure is illustrated. In particular, FIG. 1 is an isometric view of the system 10, FIG. 2 is a partial front perspective view of the system 10 showing four cutting and container filling units 11 thereof in greater detail, FIG. 3 is an enlarged view of Section 3-3 of FIG. 2, FIG. 4 is a top front perspective view of a portion of the system 10 showing two cutting and container filling units 11 in greater detail, and FIG. 5 is a partial side perspective view illustrating a single food article cutting subassembly 24 (hereinafter “cutting subassembly 24”) of the system 10 in greater detail. The system 10 includes a frame 12, a plurality of safety doors 14, a container infeed conveyor 16, a container outfeed conveyor 18, a container lift/transfer subassembly 20, a container holder subassembly 22, a plurality of cutting subassemblies 24, a plurality of plungers 26 (see FIG. 5), a plurality of chutes 28, a food article conveyor 30, a plurality of food article pushers 32, and a control system 34. Each cutting and container filling unit 11 can include a single chute 28, a single pusher 32, a single cutting subassembly 24, and a single plunger 26. Additionally, a portion of the container holder subassembly 22 and the container lift/transfer subassembly 20 can be associated with each cutting and container filling unit 11, which will be apparent from the following disclosure. The system 10 can be pneumatically operated such that the control system 34 can control a pneumatic system to operate and move the foregoing various components of the system 10, as discussed in greater detail below.

The container infeed conveyor 16 generally includes a continuously looping infeed belt 36 and guide rails 38. The continuously looping infeed belt 36 can be motor driven and includes a plurality of container positioners 40 that are each configured to receive and securely position an empty container 42a, while the guide rails 38 ensure that the containers 42a are laterally secured within the container positioners 40 and do not fall off the infeed belt 36. The container infeed conveyor 16 can extend from an interior of the frame 12 to an exterior of the frame 12 such that empty containers 42a can be placed on the infeed belt 36 by hand and drawn into the frame 12 by the infeed belt 36 for filling with cut food articles. It should be understood that in some aspects the container infeed conveyor 16 can be automatically fed empty containers 42s by an automated device instead of by hand. The container outfeed conveyor 18 can be positioned laterally adjacent the container infeed conveyor 16 and extend from the interior of the frame 12 to the exterior of the frame 12. The container outfeed conveyor 18 includes a continuously looping outfeed belt 44, which can be motor driven. The outfeed belt 44 is configured to receive filled containers 42b, e.g., containers filled with cucumber spears, from the container holder subassembly 22 and transfer the filled containers 42b from the system 10 to a downstream device or operator, e.g., to a downstream device or operator that fills the containers 42b with liquid and seals the filled containers 42b.

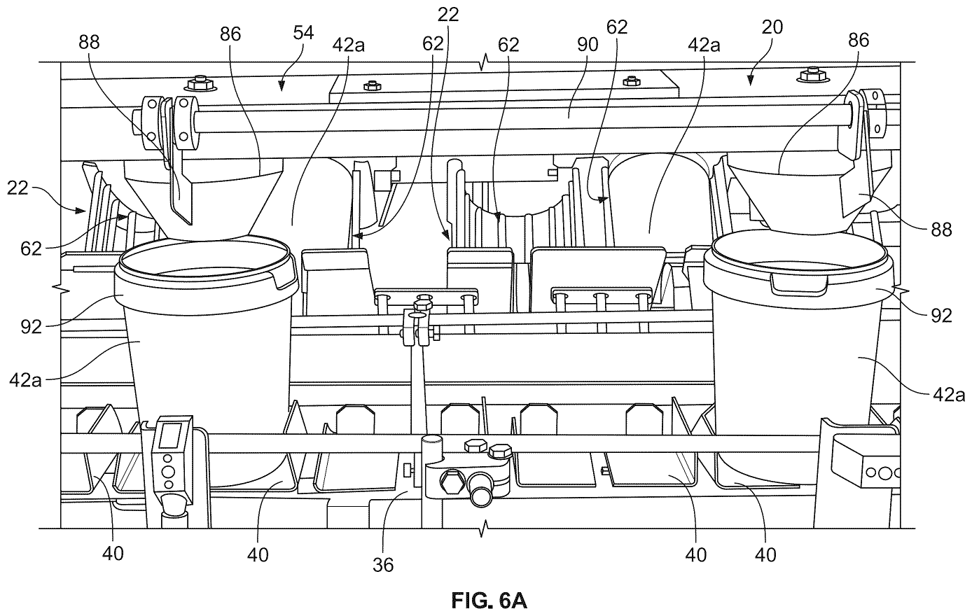

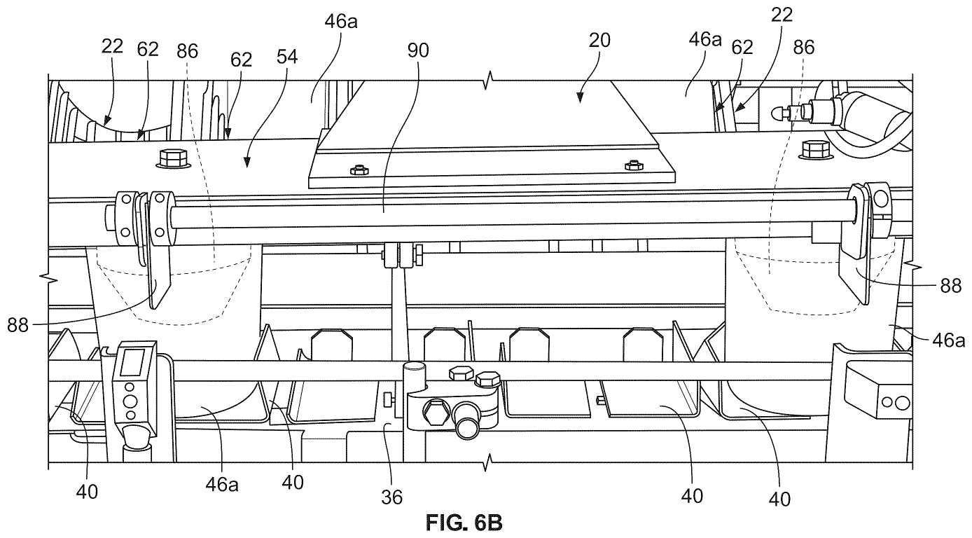

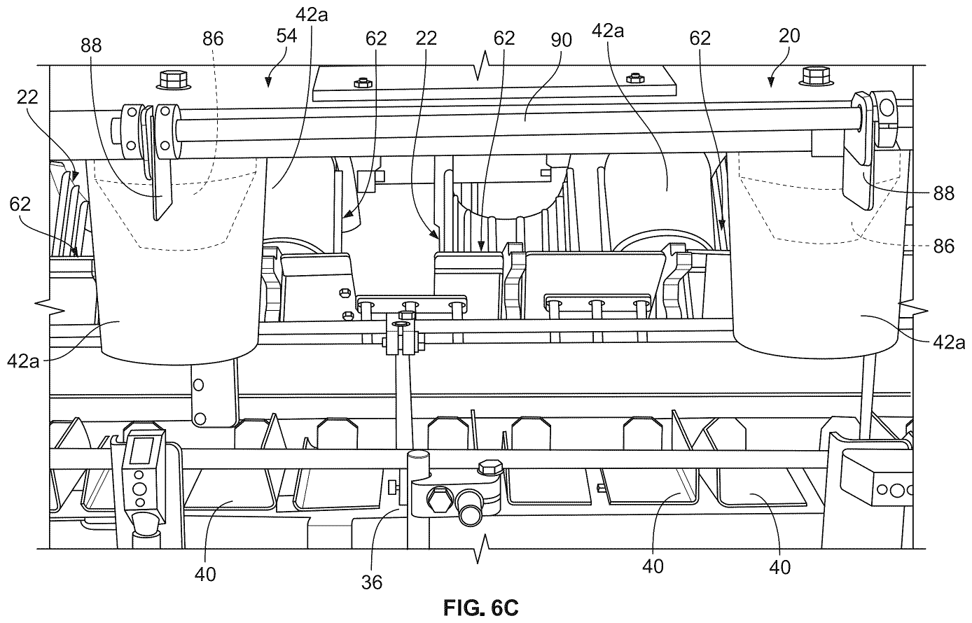

The container lift/transfer subassembly 20 includes a chassis 46, pinion gears 48 connected by an axle 50, a plurality of slide rails 52 extending between opposing portions of the chassis 46, and a container transfer sled 54 slidably mounted to the slide rails 52 by one or more sleeves 56. The container lift/transfer subassembly 20 is movably mounted to the frame 12 with the pinion gears 48 engaging racks 58 secured to the frame 12. In this regard, the container lift/transfer subassembly 20 can be mechanically engaged with one or more linear actuators 60, e.g., pneumatic linear actuators, which can be configured to vertically raise or lower the container lift/transfer subassembly 20, e.g., along the y-axis of FIG. 1. The pinion gears 48 engage and travel along the racks 58 as the container lift/transfer subassembly 20 is raised and lowered. Additionally, the container transfer sled 54 is configured to slide forward and rearward along the slide rails 52, e.g., along the z-axis of FIG. 1. In particular, one or more linear actuators 60, e.g., pneumatic linear actuators, can be mechanically engaged with the container transfer sled 54 and the chassis 46 of the container lift/transfer subassembly 20 to move the container transfer sled 54 linearly along the z-axis of FIG. 1, e.g., forward and rearward. The linear actuators 60 can be controlled by the control system 34, which can cause pistons thereof to extend and retract, e.g., using a pneumatic system and compressed air. The container lift/transfer subassembly 20 functions to pick-up empty containers 42a from the container infeed conveyor 16 and transfer the empty containers 42a to the container holder subassembly 22 for filling with cut food articles, e.g., cucumber spears, which is discussed in greater detail in connection with FIGS. 6A-6C.

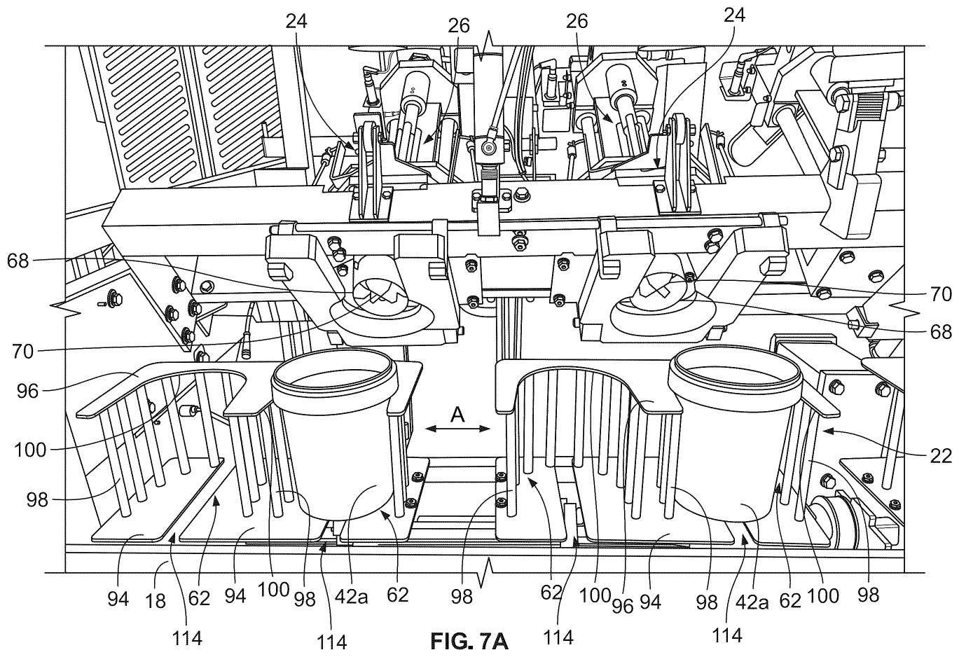

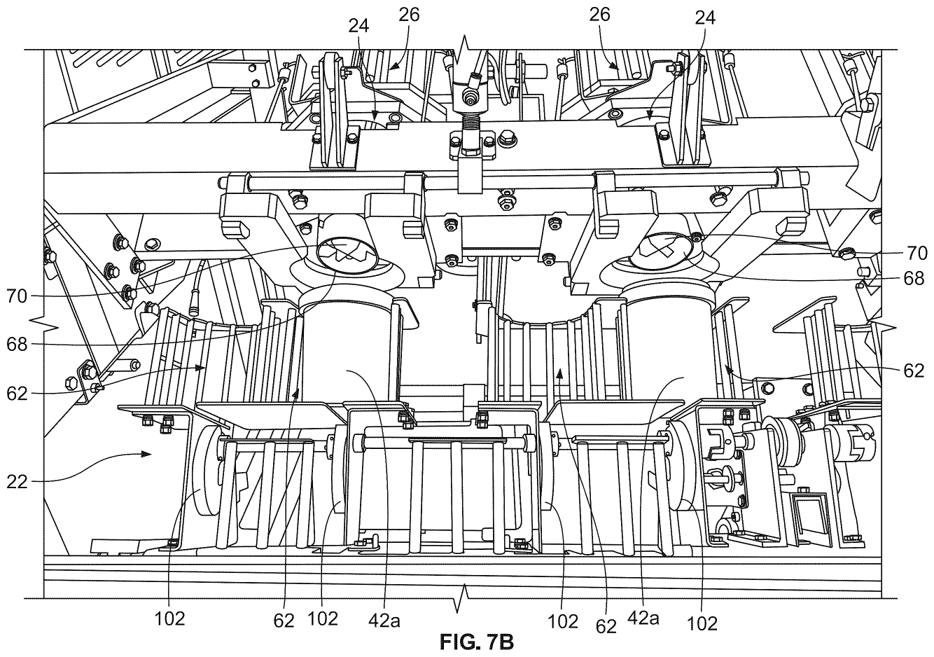

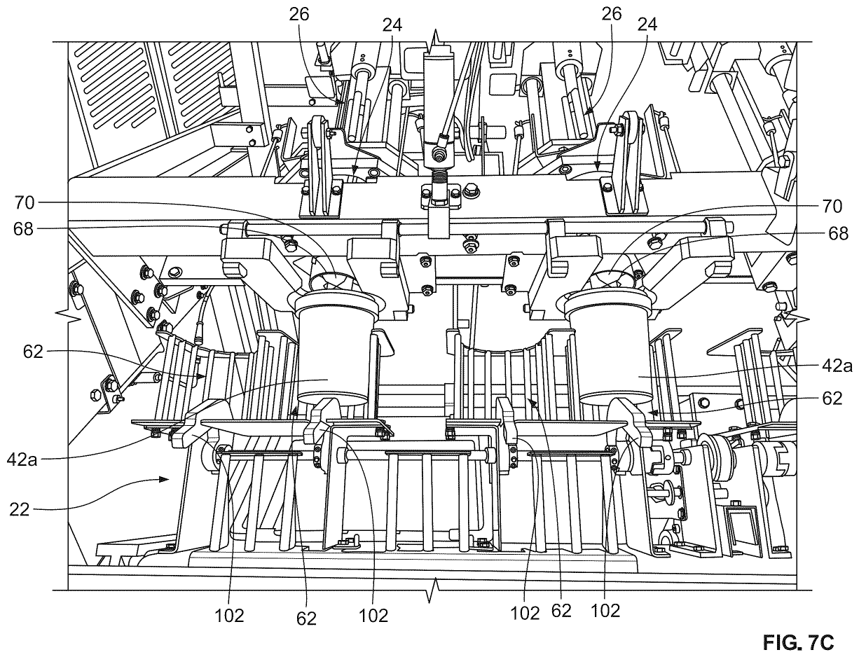

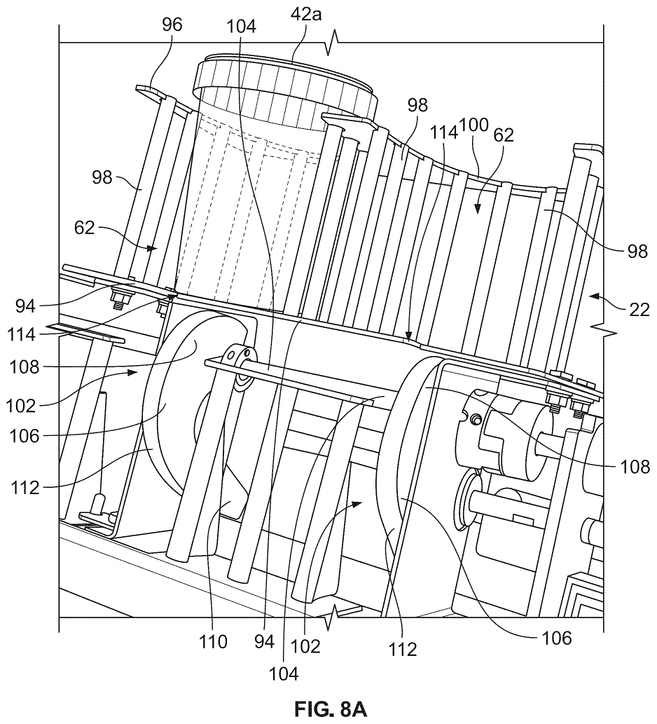

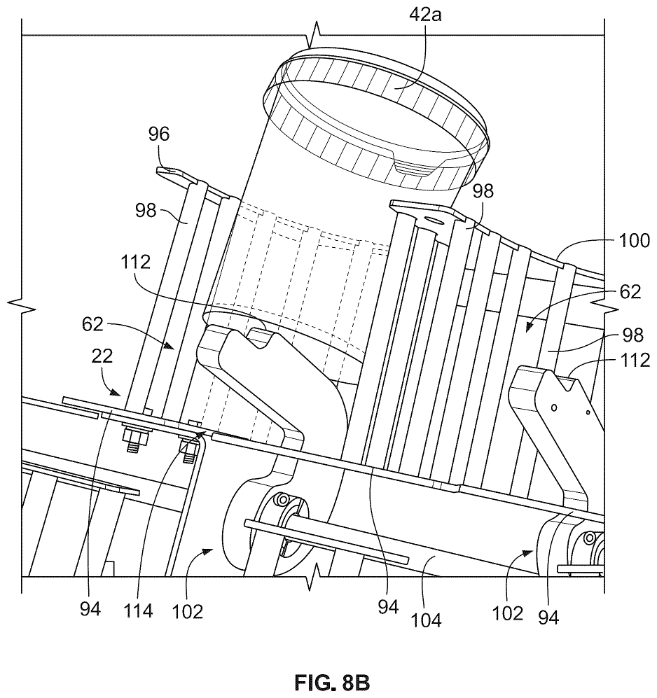

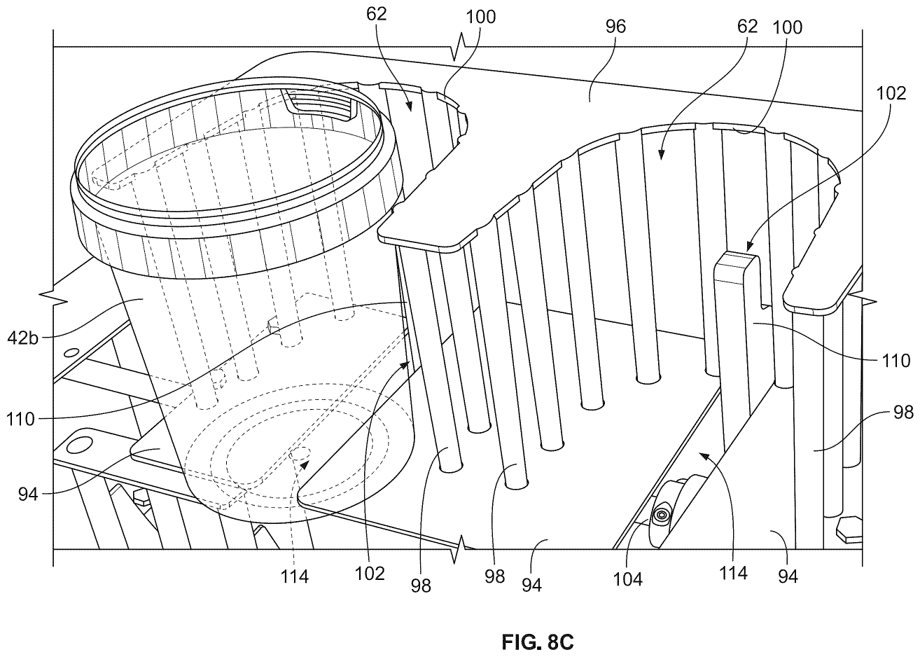

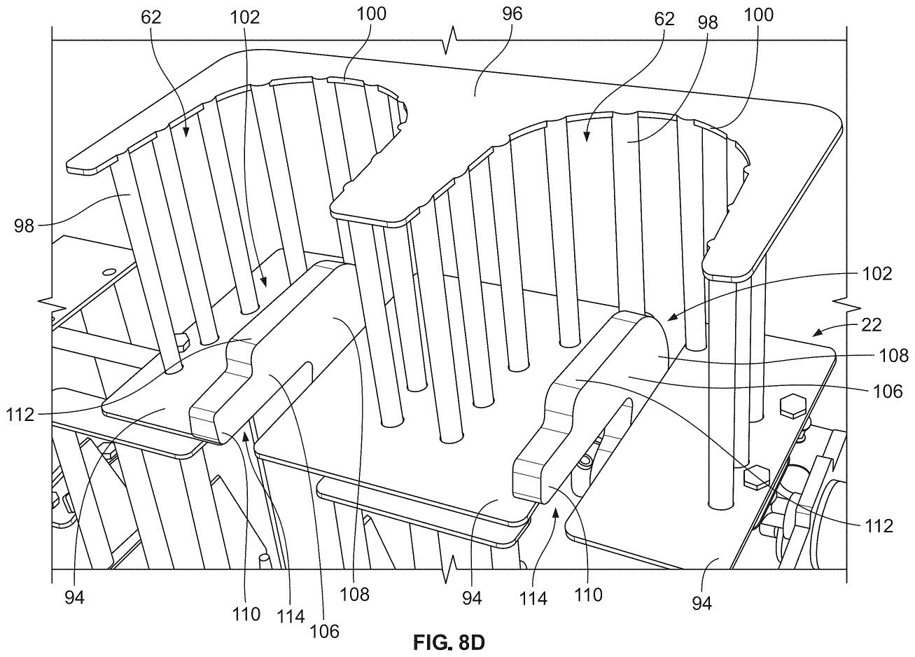

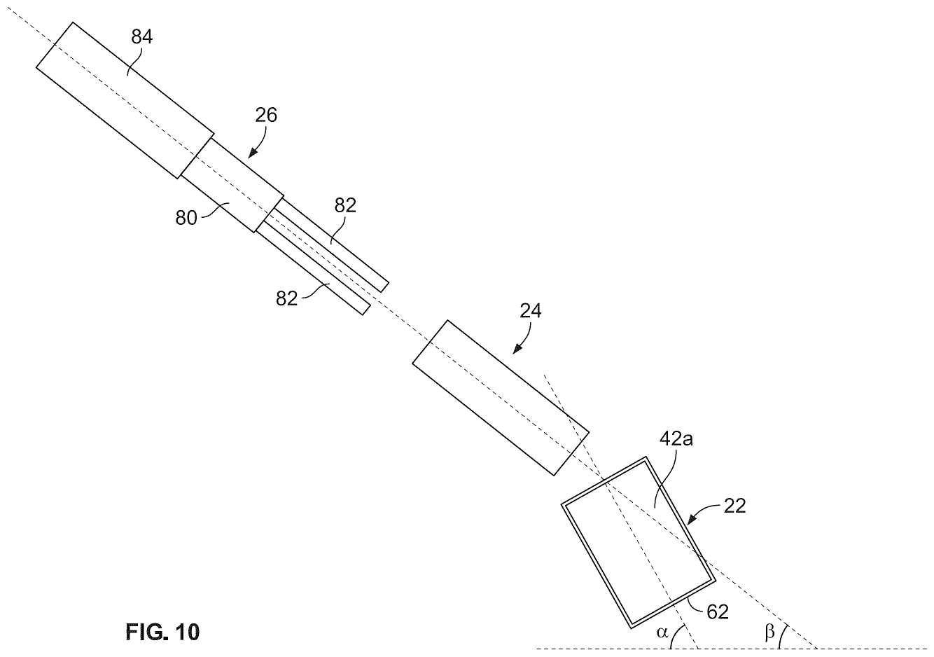

The container holder subassembly 22 includes a plurality of container receptacles 62 that are arranged in pairs, with each pair of container receptacles 62 being associated with a single cutting and container filling unit 11 and a single cutting subassembly 24. Each of the container receptacles 62 is configured to receive an empty container 42a from the container lift/transfer subassembly 20. The container holder subassembly 22 is mounted such that it can translate linearly and be rotated about an axis. In particular, the container holder subassembly 22 can be moved linearly, e.g., along the x-axis of FIG. 1, to place containers 42a held by the container receptacles 62 beneath a respective cutting subassembly 24 loaded with a cucumber for cutting. Additionally, the container holder subassembly 22 can be tilted rearward, e.g., rotated about the x-axis of FIG. 1, so that containers 42a held by the container receptacles 62 are placed below a cutting subassembly 24 and positioned to receive cucumber spears, as discussed in connection with FIGS. 7A-7C and 10. In this regard, the container holder subassembly 22 can be mounted to a rotatable and translatable shaft that can be pneumatically driven and controlled by the control system 34. The container holder subassembly 22 can also eject filled containers 42b onto the outfeed belt 44. Operation of the container holder subassembly 22, including ejection of filled containers 42b, is discussed in greater detail below in connection with FIGS. 7A-8D.

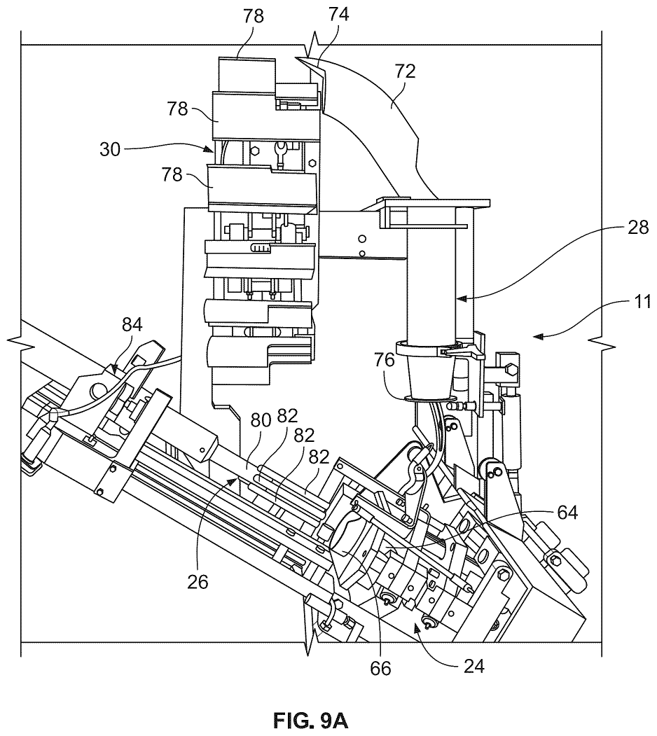

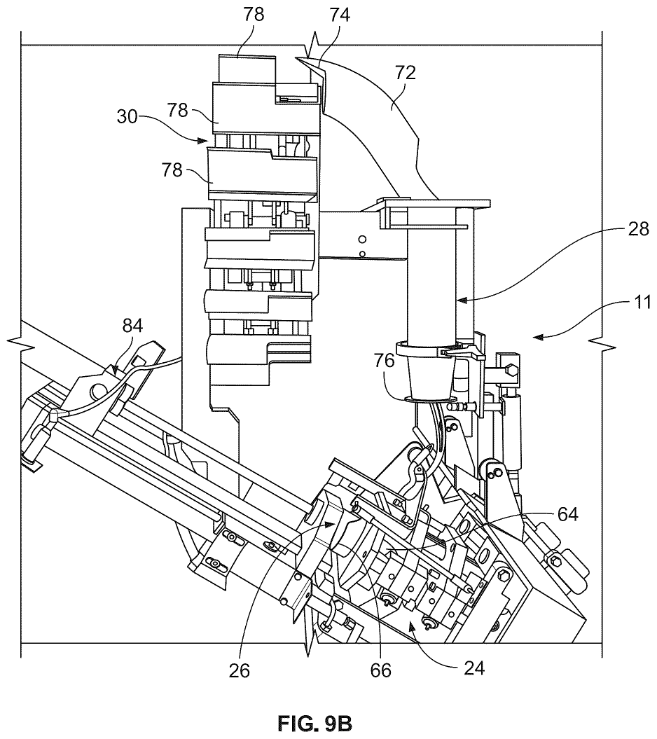

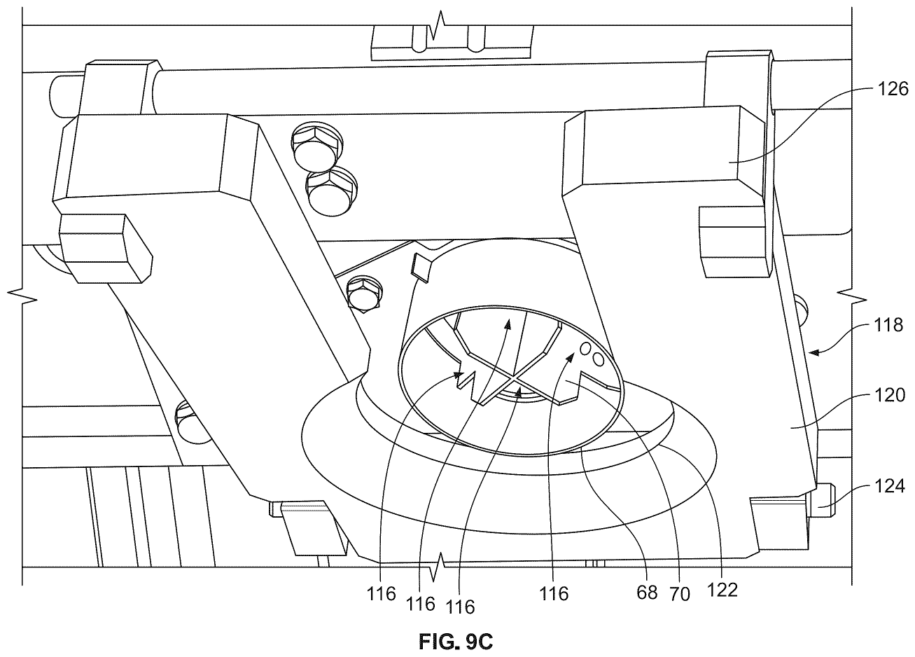

Each of the cutting subassemblies 24, a single one of which is illustrated in FIG. 5, includes a hollow body 64 extending between an open top 66 and an open bottom 68 (see, e.g., FIG. 9C), and is associated with a respective plunger 26 and chute 28. Cutting blades 70 (see, e.g., FIG. 9C) are disposed within the hollow body 64 of the cutting subassembly 24 and are configured to cut a food article, e.g., cucumber, into a plurality of sections, e.g., spears, slabs, etc. The cutting subassemblies 24 are rotatably mounted such that each can rotate, e.g., about the x-axis of FIG. 1, between a first position in which it is in axial alignment with the associated chute 28 and a second position in which it is in axial alignment with the associated plunger 26. In this regard, each of the cutting subassemblies 24 can be mounted to a shaft, and pneumatically driven and controlled by the control system 34 to rotate about the shaft. Accordingly, each of the cutting subassemblies 24 can be controlled, e.g., rotated, individually. Each cutting subassembly 24 can receive a food article from the chute 28 when it is in the first position and axially aligned with the chute 28. In particular, the food article can enter the hollow body 64 of the cutting subassembly 24 through the open top 66, and be held therein until the cutting subassembly 24 is placed in the second position. When the cutting subassembly 24 is in the second position and axially aligned with the associated plunger 26, the plunger 26 can be inserted into the hollow body 64 through the open top 66 to force the food article contained therein across the cutting blades 70 and out from the open bottom 68. The cutting subassemblies 24, and operation thereof, are discussed in greater detail in connection with FIGS. 9A-9C.

As shown in FIG. 5, each of the chutes 28 includes a hollow body 72 that extends from an open top end 74 to an open bottom end 76. The open top end 74 is positioned adjacent the food article conveyor 30 while the open bottom end 76 is positioned adjacent the open top 66 of the respective cutting subassembly 24, e.g., when the cutting subassembly 24 is in the first position and aligned with the chute 28. The open top end 74 is sized and configured to receive a food article, e.g., a cucumber, from the food article conveyor 30, which is a closed loop conveyor that includes a plurality of food article dishes 78 that are sized and shaped to receive a particular food article, e.g., the food article dishes 78 can be elongated and curved to receive a cucumber. The food article conveyor 30 can be a continuous loop that extends to outside of the frame 12 such that the food article dishes 78 can be hand fed with food articles and circulated to the chutes 28. However, it should be understood that the food article conveyor 30 could alternatively be automatically fed by an automated device configured to perform such operation. The food article conveyor 30 can be controlled by the control system 34 and operated to circulate the food article dishes 78 from a position where they can be fed a food article to a position that is immediately adjacent an open top end 74 of a chute 28. In this regard, the food article conveyor 30 can be moved incrementally, as opposed to continuously, so that the food article dishes 78 are incrementally moved until they are aligned with the open top ends 74 of the chutes 28.

When the food article dishes 78, with food article loaded thereon, are aligned with the adjacent open top ends 74 of the chutes 28 the control system 34 can actuate the food article pushers 32, which can be elongated flat plates that are mounted to a rotatable axle, to push the food articles off of the food article dishes 78 and into the open top ends 74 of the chutes 28. The food articles enter the chutes 28 through the open top ends 74, traverse through the hollow body 72 by way of gravity, exit the chutes 28 through the open bottom end 76, and enter the hollow body 64 of the cutting subassemblies 24 through the open tops 66 thereof. Once loaded with a food article, the cutting subassemblies 24 can be rotated to the second position in which each is in axial alignment with the associated plunger 26. The plungers 26 can then be actuated by the control system 34 to be inserted into the hollow body 64 of the cutting subassembly 24 through the open top 66 to force the food article contained therein across the cutting blades 70 and out from the open bottom 68. In this regard, each plunger 26 can include a body 80 and a plurality of arms 82, e.g., four arms, extending therefrom. Each plunger 26 can be driven by a linear actuator 84, e.g., a pneumatic linear actuator, that is controlled by the control system 34, which can cause a piston thereof to extend and retract, e.g., using a pneumatic system and compressed air, thus causing the plunger 26 to extend and retract, e.g., into and out of the respective cutting subassembly 24.

FIGS. 6A-6C are detailed views illustrating the container lift/transfer subassembly 20 of the system 10 in greater detail. In particular, FIGS. 6A-6C illustrate the container transfer sled 54 of the container lift/transfer subassembly 20 in different positions showing operation thereof. The container transfer sled 54 includes, in addition to those components previously noted, a plurality of centering devices 86 and a plurality of hooks 88 mounted to a rotatable shaft 90, which can be rotated by a pneumatic device or motor controlled by the control system 34. The centering devices 86 can be cone shaped and are configured to be inserted into an empty container 42a to center and properly position the empty container 42a for transfer. The hooks 88 are mounted to the rotatable shaft 90 such that they rotate therewith. In this regard, the hooks 88 are sized and shaped to be positioned under and grasp a top rim 92 of the empty containers 42a when rotated by the rotatable shaft 90.

As previously noted, the container transfer sled 54 is slidably mounted to the slide rails 52 by one or more sleeves 56, which allows the container transfer sled 54 to slide forward and rearward along the slide rails 52, e.g., along the z-axis of FIG. 1, using one or more of the linear actuators 60 (see FIG. 4). This movement allows the container transfer sled 54 to move into a first position in which the centering devices 86 are positioned above empty containers 42a that are secured within container positioners 40 of the infeed belt 36, as shown in FIG. 6A.

Once in the first position, the container transfer sled 54 can be lowered into a second position in which the centering devices 86 are within the empty containers 42a, and the hooks 88 can then be rotated, e.g., by rotating the rotatable shaft 90, to securely engage the underside of the top rim 92 of the respective empty container 42a, as shown in FIG. 6B. In this regard, the container transfer sled 54 can be lowered by lowering the entire container lift/transfer subassembly 20 using one or more of the linear actuators 60 and pinion gears 48, as previously discussed. Once the hooks 88 have securely engaged the empty containers 42a, the container lift/transfer subassembly 20, including the container transfer sled 54, can be raised using one or more of the linear actuators 60 and pinion gears 48 to lift the empty containers 42, as shown in FIG. 6C. Next, the container transfer sled 54 can be translated rearward, e.g., along the z-axis of FIG. 1, using one or more of the actuators 60 until the containers 42a held thereby are positioned above the container receptacles 62 of the container holder subassembly 22, at which point the container lift/transfer subassembly 20, including the container transfer sled 54, can be lowered and the containers 42a can be released onto the container receptacles 62 by rotating the hooks 88 to unlatch from the container rims 92. Once released by the container transfer sled 54, the empty containers 42a are positioned within the respective container receptacles 62 and ready for filling, as shown in FIG. 7A. Once the empty containers 42a are released, the container lift/transfer subassembly 20, including the container transfer sled 54, can be lifted and the container transfer sled 54 can be moved to pick-up additional empty containers 42a.

FIGS. 7A-7C are detailed views illustrating the container holder subassembly 22 of the system 10 in different positions showing operation thereof. As previously noted, the container holder subassembly 22 is positioned adjacent the container outfeed conveyor 18 and below the cutting subassemblies 24, and includes a plurality of container receptacles 62 that are arranged in pairs, with each pair of container receptacles 62 being associated with a single cutting and container filling unit 11 and a single cutting subassembly 24. The container receptacles 62 are sized and shaped to receive an empty container 42a from the container lift/transfer subassembly 20. In particular, each pair of container receptacles 62 can include one or more bottom platforms 94 on which the containers 42a rest, a top rail 96, and a plurality of posts 98 extending between the bottom platforms 94 and the top rail 96 forming a fence. Each of the top rails 96 can include two concavities 100 that are configured to receive and secure the empty containers 42a in place, as shown in FIG. 7A. The container holder subassembly 22 is configured to move laterally in the direction of Arrow A, e.g., along the x-axis of FIG. 1, in order to alternate which container receptacle 62 is positioned below the adjacent and associated cutting subassembly 24.

Additionally, as previously noted, the container holder subassembly 22 is rotatable between a first position in which it is upright and the container receptacles 62 can receive an empty container 42a (see FIG. 7A), and a second position in which it is tilted rearward (see FIGS. 7B and 7C), e.g., rotated about the x-axis of FIG. 1. When the container holder subassembly 22 is in the second position, the containers 42a held by the container receptacles 62 are below the associated cutting subassembly 24 and in a position to receive cut food articles, e.g., cucumber spears, as shown in FIG. 7B. Additionally, when the container holder subassembly 22 is in the second position, each of the containers 42a can be lifted using a container lift and ejection mechanism 102 to place the container 42a in closer proximity to the open bottom 68 of the associated cutting subassembly 24 and in position for receiving cut food articles, e.g., cucumber spears, exiting through the open bottom 68 of the cutting subassembly 24, as shown in FIG. 7C and discussed in greater detail in connection with FIGS. 8A-8D.

FIGS. 8A-8D are detailed views illustrating the container lift and ejection mechanisms 102 in different positions showing operation thereof. The container lift and ejection mechanisms 102 are mounted to a shaft 104, which can rotate the container lift and ejection mechanisms 102 in a first direction, e.g., a clockwise direction, and in a second direction, e.g., a counterclockwise direction. Rotation of the shaft 104, and in turn the container lift and ejection mechanisms 102, can be controlled by the control system 34. For example, the shaft 104 can be driven by a motor or a pneumatic system controlled by the control system 34. The container lift and ejection mechanisms 102 include a body 106 that is generally “J” shaped and extends from a shaft engaging region 108 to an arm 110. The body 106 additionally includes a side surface 112 that is configured to engage and lift a container 42a. In particular, the container lift and ejection mechanisms 102 are generally rotatable between three positions. The first position is generally shown in FIG. 8A, the second position is generally shown in FIG. 8B, and the third position is generally shown in FIG. 8D. FIG. 8C generally illustrates the container lift and ejection mechanisms 102 transitioning between the second and third positions.

When in the first position, the container lift and ejection mechanisms 102 are generally below the bottom platforms 94 on which the containers 42a rest such that the containers 42a are in a lowered position. The container lift and ejection mechanisms 102 are then rotated clockwise by the shaft 104, which causes the container lift and ejection mechanisms 102 to rotate through a gap 114 between the bottom platforms 94 and engage a bottom of the containers 42a with the side surface 112 thereof. Continued rotation of the container lift and ejection mechanisms 102 causes the bottom of the containers 42a to ride along the side surface 112 until the container lift and ejection mechanisms 102 comes to rest in the second position, as shown in FIG. 8B. When the container lift and ejection mechanisms 102 are in the second position, the containers 42a are in a lifted position resting on the side surface 112 of the arm 110 of the container lift and ejection mechanisms 102. As previously noted in connection with FIG. 7C, when the containers 42a are in the lifted position, they are in closer proximity to the open bottom 68 of the associated cutting subassembly 24 and in position for receiving cut food articles, e.g., cucumber spears, exiting through the open bottom 68 of the cutting subassembly 24.

Once the containers 42a have been filled with cut food articles, the container lift and ejection mechanisms 102 are rotated counterclockwise from the second position to the third position. In particular, as the container lift and ejection mechanisms 102 are rotated counterclockwise the filled containers 42b are lowered and come to rest on the bottom platforms 94, as shown in FIG. 8C. Continued counterclockwise rotation of the container lift and ejection mechanisms 102 causes the arm 110 of each container lift and ejection mechanism 102 to rotate through the gap 114 between the bottom platforms 94 and contact a rear portion of the filled containers 42b, as shown in FIG. 8C. As the container lift and ejection mechanisms 102 continue to rotate counterclockwise into the third position, the arms 110 push the filled containers 42b off of the bottom platforms 94 and onto the outfeed belt 44 that is adjacent the container holder subassembly 22 (e.g., as shown in FIG. 3). FIG. 8D illustrates the container lift and ejection mechanisms 102 in the third position where the filled containers 42b have been ejected from the container receptacles 62 in which they were previously positioned. Once the containers 42b have been ejected, the container lift and ejection mechanisms 102 are rotated back into the first position such that the container receptacles 62 are ready to receive new empty containers 42a.

FIGS. 5, 9A, and 9B are partial side perspective views illustrating a single cutting subassembly 24 and plunger 26 of the system 10 in different positions illustrating operation thereof. As previously noted, the cutting subassemblies 24 are rotatably mounted such that each can rotate, e.g., about the x-axis of FIG. 1, between a first position in which it is in axial alignment with the associated chute 28 and a second position in which it is in axial alignment with the associated plunger 26. FIG. 5 illustrates the cutting subassembly 24 in the first position, FIG. 9A illustrates the cutting subassembly 24 in the second position with the associated plunger 26 in a retracted position, and FIG. 9B illustrates the cutting subassembly 24 in the second position with the associated plunger 26 in an extended position.

When in the first position, each cutting subassembly 24 is positioned with the open top 66 thereof adjacent the open bottom end 76 of the respective chute 28, and can receive a food article from the chute 28. As previously discussed, the food article is provided to the chute 28 from the food article conveyor 30, traverses the chute 28, enters the cutting subassembly 24 through the open top 66 thereof, and is retained within the hollow body 64 for cutting. Once the cutting subassembly has received a food article, it is moved, e.g., rotated, into the second position in which it is aligned with the associated plunger 26, as shown in FIG. 9B.

When the cutting subassembly 24 is in the second position, the container holder subassembly 22 is in the second position, and the containers 42a held by the container receptacles 62 are lifted by the container lift and ejection mechanism 102 (see FIG. 7C), the associated plunger 26 can be axially extended such that the arms 82 thereof are inserted through the open top 66 of the cutting subassembly 24 and into the hollow body 64, as shown in FIG. 9B, thus forcing the food article contained therein across the cutting blades 70 and out from the open bottom 68, as shown in FIG. 9C. The cut food article, e.g., cucumber spears, are pushed out from the open bottom 68 of the cutting subassembly 24 by the arms 82 of the plunger 26 and fall into the container 64a positioned below the cutting subassembly 24. The plunger 26 is then retracted from the cutting subassembly 24, which can then be rotated back into the first position while the container holder subassembly 22 remains reclined in its second position. The foregoing process can then be repeated for a set number of food articles until the container 64b is filled, e.g., with cucumber spears.

Moreover, while the cutting subassembly 24 and the plunger 26 are axially aligned during the cutting process, the container 42a held by the container holder subassembly 22 can be positioned at a different angle, as shown in FIG. 10, which is a schematic diagram illustrating an exemplary angular orientation of the cutting subassembly 24, the plunger 26, the container holder subassembly 22, and the container 42a of the system 10. For example, the container 42a held by the container holder subassembly 22 can be at a first angle α with respect to a horizontal plane (e.g., 45°) while the cutting subassembly 24 and the plunger 26 can be at a second angle β (e.g., 30°) with respect to the same horizontal plane, and the first angle α can be greater than the second angle β. Additionally, the container 42a can be positioned slightly below the cutting subassembly 24. This configuration allows the cut food articles to be ejected from the open bottom 68 of the cutting subassembly 24 into the container 42a and fall against the bottom wall of the container 42a due to gravity, which creates an opening for the next batch of cut food articles to enter the container 42a and prevents the new cut food articles from compressing the cut food articles already contained by the container 42a.

It is additionally noted that the arms 82 of the plunger 26 can be sized, shaped, and configured to be inserted through spaces 116 between the cutting blades 70 in order to push the cut food article fully through the cutting blades 70 and out from the cutting subassembly 24. The plunger 26 can also be configured so that it has the same amount of arms 82 as spaces 116 between cutting blades 70, e.g., four arms 82 and four spaces 116 as shown in FIG. 9C, such that each space 116 has an arm 82 that mates therewith.

Each cutting subassembly 24 can also include a container release mechanism 118, as shown in FIG. 9C. The container release mechanism 118 can include a paddle 120 having a central opening 122 surrounding the open bottom 68 of the cutting subassembly 24 that allows cut food articles to pass therethrough. The paddle 120 can be rotatably mounted on an shaft 124 and driven by an actuator, e.g., a pneumatic actuator. Specifically, the actuator can cause a front end 126 of the paddle 120 to pulse or move a short distance downward, e.g., a couple centimeters, causing the paddle 120 to partially rotate about the shaft 124. When pulsed downward, the paddle 120 can strike a full container 64b positioned adjacent thereto in order to dislodge the container 64b. In particular, if a container 64b is filled with too many cut food articles, and one of the cut food articles is lodged in the container 64b and stuck in one of the spaces 116 between cutting blades 70, then the container 64b might not lower when the container lift and ejection mechanism 102 rotates to lower the container 64b. In such instances, the paddle 120 will dislodge the stuck container 64b allowing the container 64b to be lowered and ejected from the container receptacle 62 onto the container outfeed conveyor 18.

Once the containers 42b are filled, and dislodged if necessary, they can be lowered by the container lift and ejection mechanisms 102, the container holder subassembly 22 can be moved (e.g., rotated) into the first position in which it is upright, and the container lift and ejection mechanisms 102 can eject the filled containers 42b onto the outfeed belt 44 of the container outfeed conveyor 18. Additionally, while the filled containers 42b are being ejected, the container lift/transfer subassembly 20 can place empty containers 42a into the empty container receptacles 62 of the container holder subassembly 22 and the cutting subassemblies 24 can receive a food article, which minimizes the downtime of the system 10 and increases the overall duty cycle of the system 10.

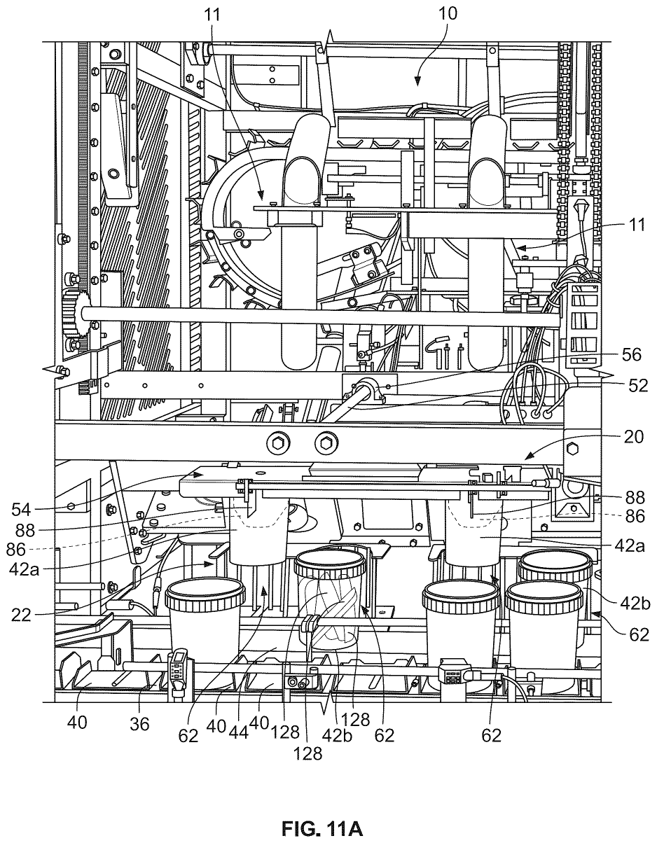

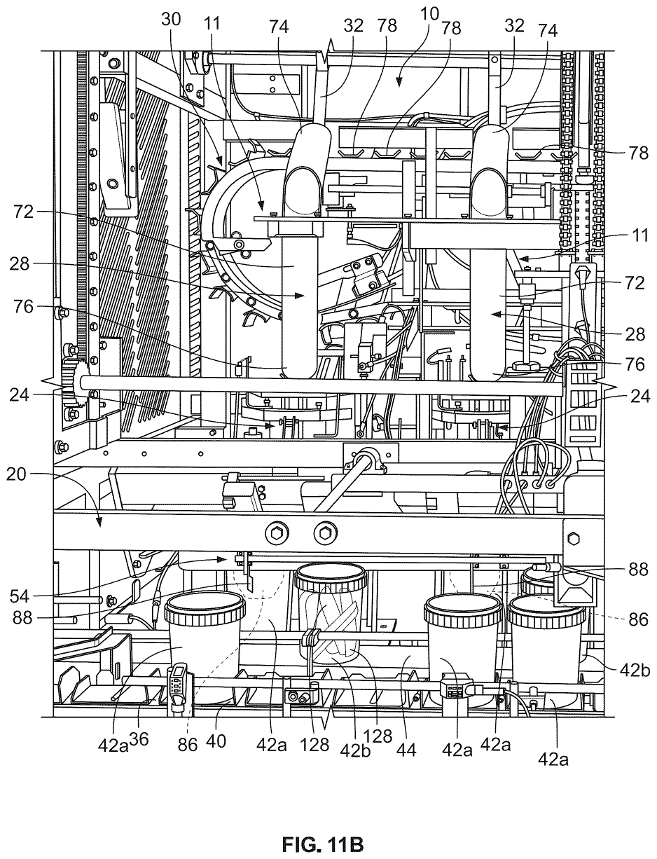

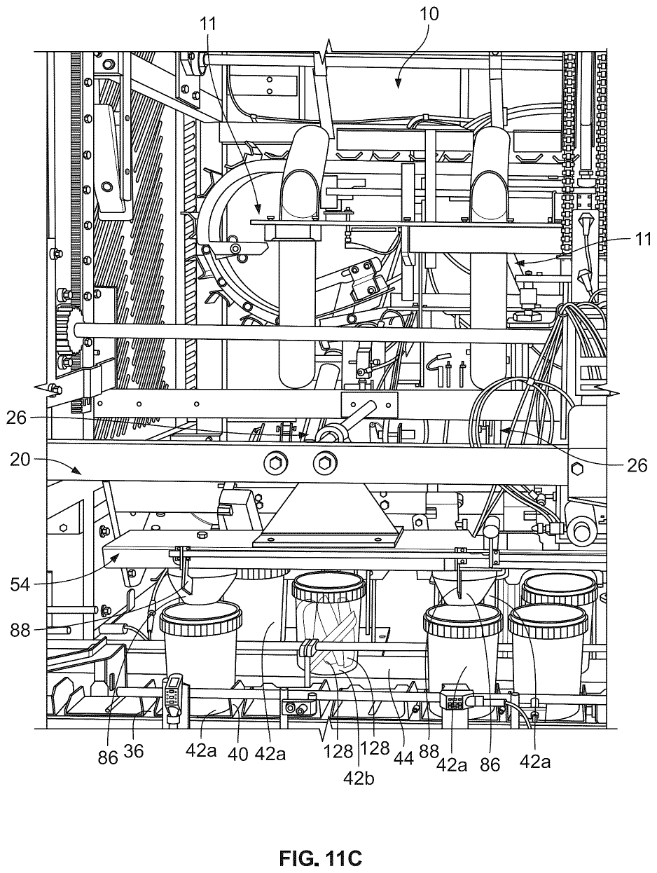

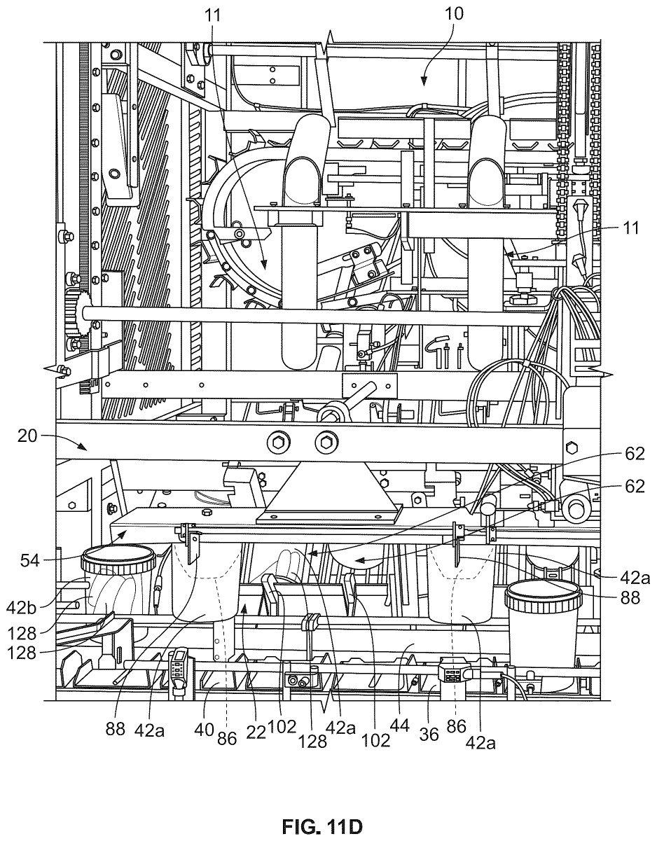

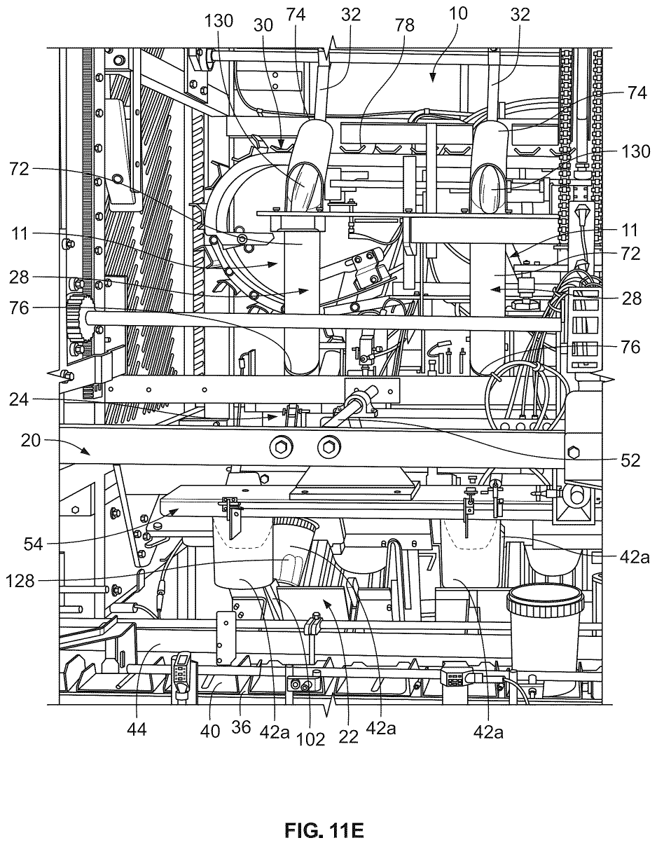

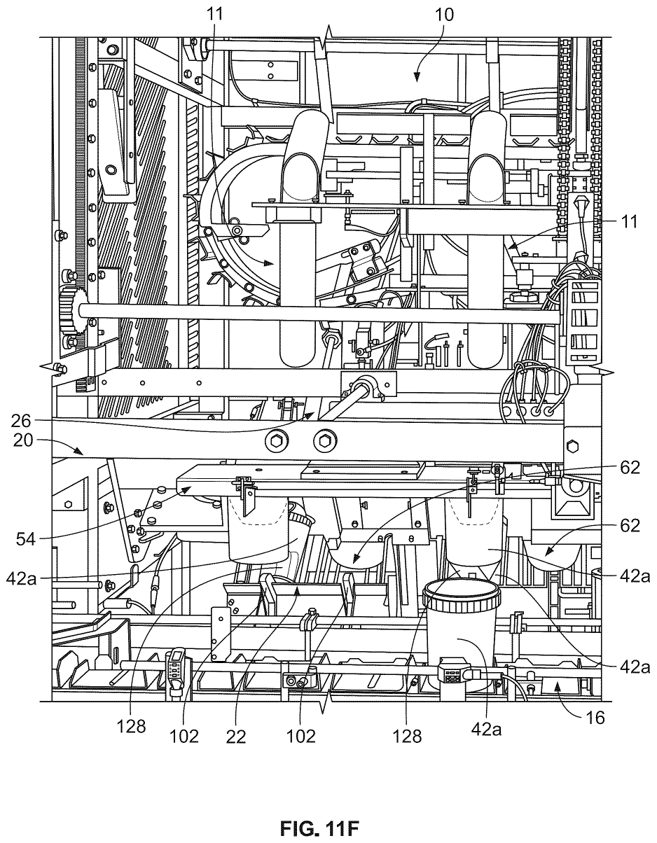

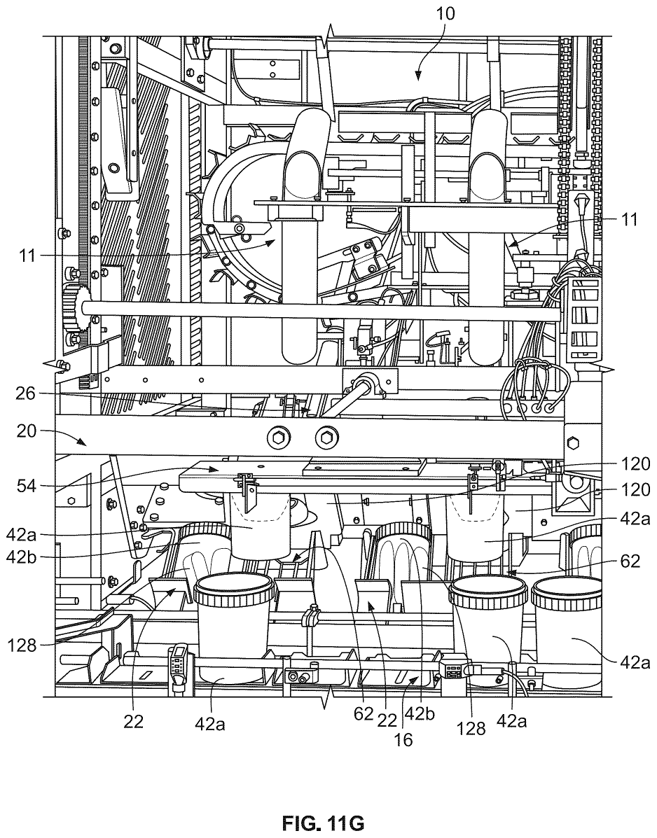

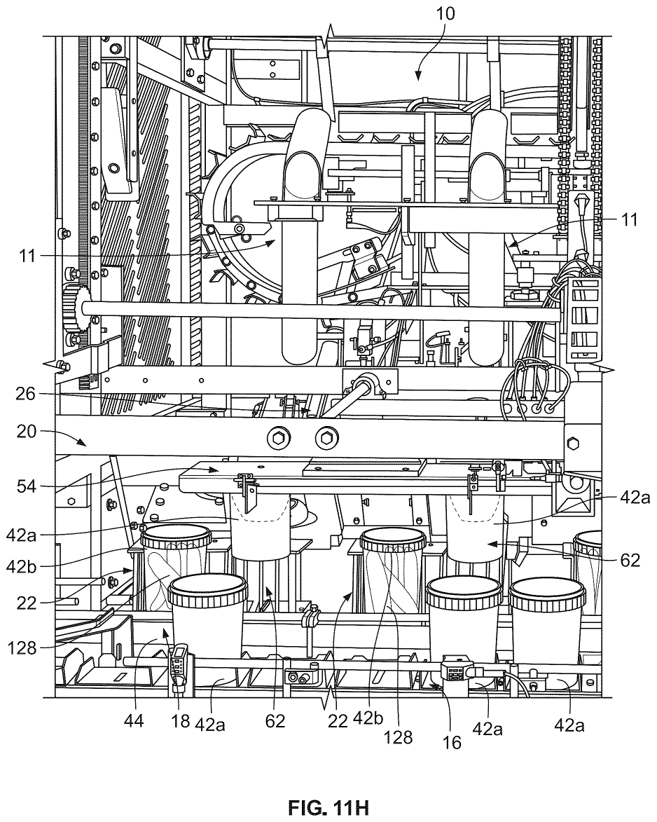

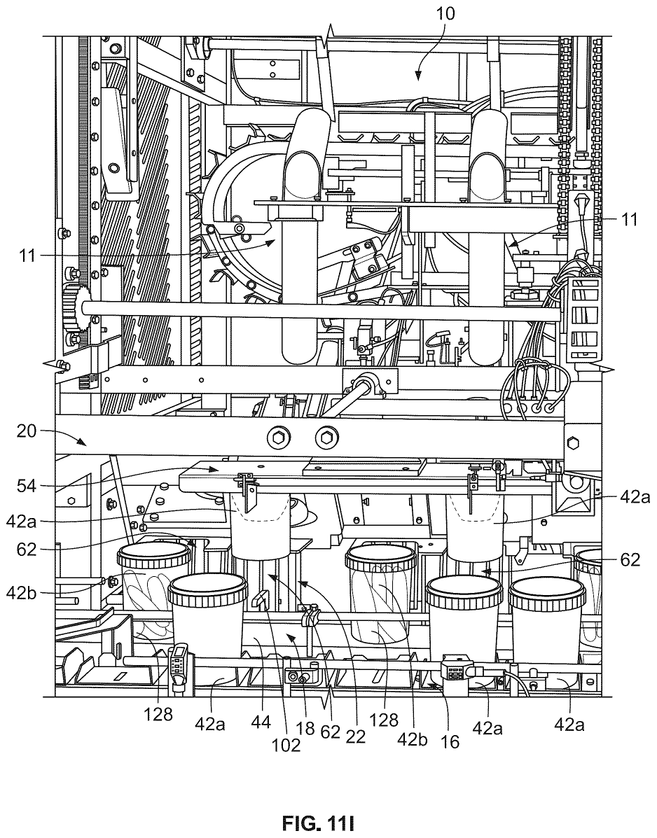

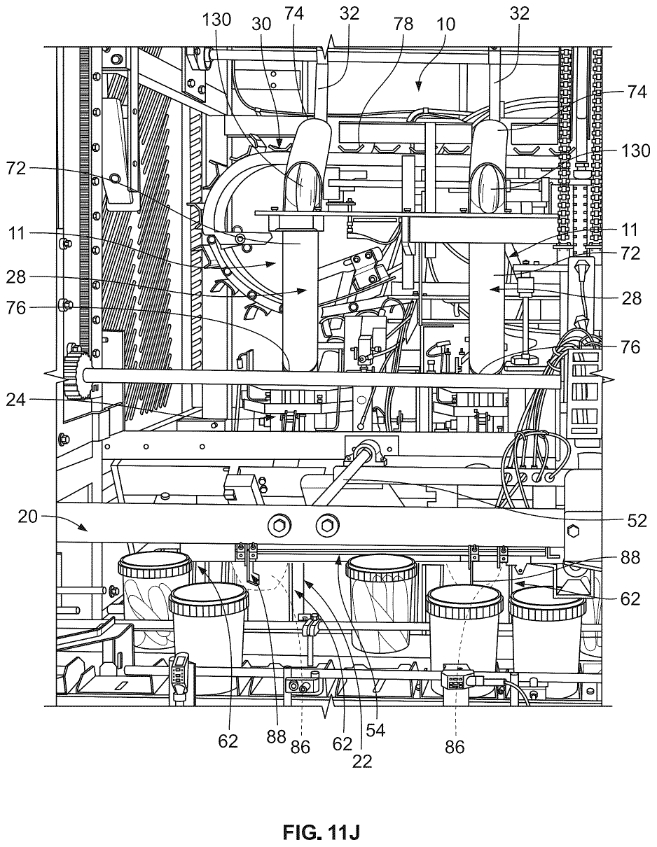

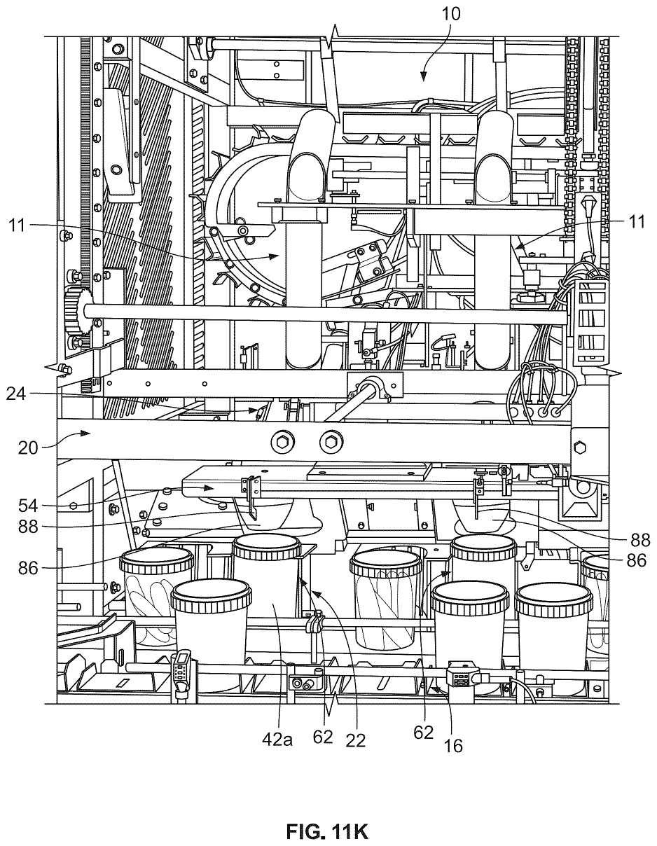

Turning now to FIGS. 11A-11K, which are partial front perspective snapshots of the system 10 at sequential points in time illustrating the position of the various components thereof during different stages of operation of the system 10. That is, FIGS. 11A-11K are snapshots illustrating sequential operation of two cutting and container filling units 11 of the system 10.

In FIG. 11A, the system 10 is in the process of providing empty containers 42a to the container holder subassembly 22 after ejecting filled containers 42b therefrom onto the outfeed belt 44. Specifically, as illustrated in FIG. 11A, the system 10 has filled multiple containers 42b with cucumber spears 128 and ejected the filled containers 42b from the respective container receptacles 62 of the container holder subassembly 22 onto the outfeed belt 44. Additionally, while ejecting the filled containers 42b, the container lift/transfer subassembly 20 has picked-up empty containers 42a from the infeed belt 36 using the container transfer sled 54 and transferred the empty containers 42a to the container holder subassembly 22. In particular, the container transfer sled 54 has grabbed the empty containers 42a from the infeed belt 36 using the centering devices 86 and hooks 88, lifted the empty containers 42a by raising the container lift/transfer subassembly 20, and translated rearward, e.g., in the z-axis direction of FIG. 1, along the rails 52 until the containers 42a held thereby are positioned above empty container receptacles 62 of the container holder subassembly 22, as described in connection with FIGS. 6A-6C.

FIG. 11B generally illustrates the container lift/transfer subassembly 20 lowering the empty containers 42a onto the container holder subassembly 22. In particular, in FIG. 11B, the container lift/transfer subassembly 20, including the container transfer sled 54, has been lowered and the hooks 88 have been rotated to unlatch from the container rims 92, thus releasing the containers 42a onto the container receptacles 62 of the container holder subassembly 22. Additionally, the cutting subassemblies 24 are upright in the first position such that each is in axial alignment with its associated chute 28, and has received a cucumber from the conveyor 30. In particular, the food article pushers 32 have been rotated forwarded and pushed cucumbers off of the food article dishes 78 and into the open top ends 74 of the chutes 28. As discussed in connection with FIG. 5, the cucumbers enter the chutes 28 through the open top ends 74, traverse through the hollow body 72 by way of gravity, exit the chutes 28 through the open bottom end 76, and enter the cutting subassemblies 24, which retain the cucumbers for cutting.

In FIG. 11C, the cutting subassemblies 24 (not visible in FIG. 11C) have been rotated from the first position, as they were in FIG. 11B, into the second position in which each is aligned with its associated plunger 26, e.g., as shown in FIG. 9A. Additionally, the container lift/transfer subassembly 20, including the container transfer sled 54, has been lifted and the container transfer sled 54 has translated forward, e.g., in the direction of the z-axis of FIG. 1, along the rails 52 until the centering devices 86 are positioned above empty containers 42a positioned within the container positioners 40 of the infeed belt 36.

FIG. 11D generally illustrates the cutting of a cucumber and picking up of new containers 42a. In particular, in FIG. 11D, the system 10 has rotated the container holder subassembly 22 into the second position in which it is tilted rearward, e.g., rotated about the x-axis of FIG. 1, with the containers 42a held by the container receptacles 62 positioned below the associated cutting subassembly 24, and lifted the containers 42a held thereby using the container lift and ejection mechanisms 102, e.g., rotated the container lift and ejection mechanisms 102 into the second position (e.g., the position shown in FIG. 8B). The system 10 has also axially extended the plunger 26 (not visible in FIG. 11D) into the cutting subassembly 24, thus forcing the cucumber held therein through the cutting blades 70 (not visible in FIG. 11D), such that the cucumber has been cut into a plurality of spears 128 that have been received by the containers 42a. The system 10 has also actuated the outfeed belt 44 causing the filled containers 42b positioned thereon to be removed. Additionally, the container lift/transfer subassembly 20 has picked-up new empty containers 42a from the infeed belt 36 using the container transfer sled 54 in order to transfer new empty containers 42a to the container holder subassembly 22 for filling. In particular, the containers 42a have been lifted by lowering the container lift/transfer subassembly 20, including the container transfer sled 54, on to the empty containers 42a with the centering devices 86 inserted into the empty containers 42a, grabbing the empty containers 42a using the hooks 88, and raising the container lift/transfer subassembly 20. Accordingly, while the system 10 is cutting a cucumber and filling the containers 42a with the cucumber spears, it is also picking up new empty containers 42a with the container lift/transfer subassembly 20 and removing the filled containers 42b with the outfeed belt 44. The overlap of these functions increases the efficiency and duty cycle of the system 10 compared to prior systems.

FIG. 11E generally illustrates the cutting subassemblies 24 returning to the first position to receive a second cucumber 130 for cutting. Specifically, in FIG. 11E, the plungers 26 (not visible in FIG. 11E) have been removed from the cutting subassemblies 24, and the cutting subassemblies 24 have been rotated from the second position to the first position, such that each is upright in axial alignment with its associated chute 28 and is in the process of receiving a second cucumber 130 from the conveyor 30. In particular, the food article pushers 32 have been rotated forwarded and pushed cucumbers 130 off of the food article dishes 78 and into the open top ends 74 of the chutes 28. Additionally, the container transfer sled 54 is in the process of translating rearward, e.g., in the direction of the z-axis of FIG. 1, along the rails 52 to place the containers 54a held thereby in position to be received by container receptacles 62 of the container holder subassembly 22.

FIG. 11F generally illustrates the cutting of a second cucumber 130 by the cutting subassemblies 24 and plungers 26. In particular, in FIG. 11F, the cutting subassemblies 24 (not visible in FIG. 11C) have received the second cucumber 130 (shown in FIG. 11E) and been rotated into the second position in which each is aligned with its associated plunger 26, e.g., as shown in FIG. 9A. Additionally, the system 10 has axially extended the plunger 26 (not visible in FIG. 11F) into the cutting subassembly 24, thereby forcing the cucumber 130 held therein through the cutting blades 70 (not visible in FIG. 11F), such that the cucumber 130 has been cut into a plurality of spears 128 that have been received by the containers 42a. It should be understood that while the foregoing figures illustrate two cucumbers 130 being cut, the cutting subassemblies 24 can receive and cut as many cucumbers 130 as necessary to fill the containers 42a consistent with the foregoing procedure. Furthermore, the container transfer sled 54 has been translated fully rearward and the container infeed conveyor 16 has been actuated to provide additional empty containers 42a.

FIG. 11G generally illustrates the preparation of the filled containers 42b for ejection and depositing of new empty containers 42a. In particular, in FIG. 11G, the full containers 42b held by the container holder subassembly 22 have been lowered, e.g., by rotating the container lift and ejection mechanisms 102 back into the first position shown in FIG. 8A and pulsing the paddle 120 to dislodge the full containers 42b if stuck, and the container holder subassembly 22 has been moved laterally, e.g., along the x-axis of FIG. 1, so that the filled containers 42b are no longer positioned beneath the cutting subassemblies 24, but instead the empty container receptacles 62 of the container holder subassembly 22 are positioned adjacent the cutting subassemblies 24 and adjacent the empty containers 42a held by the container transfer sled 54. Additionally, the plungers 26 have been withdrawn from the cutting subassemblies 24.

In FIG. 11H, the container holder subassembly 22 has been rotated from the second position to the first position in which it is upright, such that the empty containers 42a held by the container transfer sled 54 are positioned within the empty container receptacles 62 of the container holder subassembly 22, though not lowered at this point in time, and the filled containers 42b held by the container holder subassembly 22 are in position to be ejected onto the outfeed belt 44 of the container outfeed conveyor 18.

In FIG. 11I, the filled containers 42b held by the container holder subassembly 22 have been ejected onto the outfeed belt 44 of the container outfeed conveyor 18 for removal from the system 10. Specifically, the container lift and ejection mechanisms 102 have been rotated into the third position, as discussed in connection with FIG. 8D, such that the container lift and ejection mechanisms 102 have pushed the filled containers 42b out from the container receptacles 62 in which they were positioned and onto the outfeed belt 44.

FIG. 11J generally illustrates the container holder subassembly 22 received new empty containers 42a during the ejection of the filled containers 42b, as well as the cutting subassemblies 24 receiving new cucumbers 130 for cutting. In particular, in FIG. 11J, the container lift/transfer subassembly 20, including the container transfer sled 54, has been lowered and the hooks 88 have been rotated to unlatch from the container rims 92, thus releasing the containers 42a onto the container receptacles 62 of the container holder subassembly 22. Additionally, the cutting subassemblies 24 are upright in the first position such that each is in axial alignment with its associated chute 28, and is in the process of receiving a second cucumber 130 from the conveyor 30. In particular, the food article pushers 32 have been rotated forwarded and pushed cucumbers 130 off of the food article dishes 78 and into the open top ends 74 of the chutes 28. As discussed in connection with FIG. 5, the cucumbers enter the chutes 28 through the open top ends 74, traverse through the hollow body 72 by way of gravity, exit the chutes 28 through the open bottom end 76, and enter the cutting subassemblies 24, which retains the cucumber for cutting. Accordingly, the container lift/transfer subassembly 20 provides new empty containers 42a to the container holder subassembly 22 and the cutting subassemblies 24 receive whole cucumbers 130 while the filled containers 42b are being ejected from the container holder subassembly 22. This overlap in functionality provides for increased efficiency and duty cycle compared to prior systems.

In FIG. 11K, the container lift/transfer subassembly 20, including the container transfer sled 54, has been lifted while the empty containers 42a remain within the respective container receptacles 62 of the container holder subassembly 22. Additionally, the cutting subassemblies 24 (not visible in FIG. 11J) have been rotated into the second position in which each is aligned with its associated plunger 26, e.g., as shown in FIG. 9A.

Accordingly, FIGS. 11A-11I illustrate the transfer, placement, filling, and ejection of a first container 42a for each cutting and container filling unit 11, and FIGS. 11D-11K illustrate the transfer and placement of a second container for each cutting and container filling unit 11 while the first container 42a is being filled. The foregoing process can be repeated as many times as needed.

Additionally, it should be understood that, as previously noted, the operation, motion, rotation, actuation, etc. of the various components of the system 10, including, but not limited to, the container infeed conveyor 16, the container outfeed conveyor 18, the container lift/transfer subassembly 20, the container transfer sled 54, the hooks 88, the container holder subassembly 22, the container lift and ejection mechanisms 102, the cutting subassemblies 24, the container release mechanisms 118, the plungers 26, the food article conveyor 30, and the food article pushers 32 can be controlled by the control system 34. In this regard, the foregoing components can be operated by a motor and/or an actuator that can be controlled by the control system 34. For example, the system 10 can include a pneumatic system that is in communication with and causes motion of the foregoing components. Such pneumatic system can be controlled by the control system 34. Moreover, the system 10 can include various sensors, e.g., electronic sensors, motion sensors, pressure sensors, etc., and operation of the foregoing components can be tied to one or more signals generated by the sensors and performed automatically. However, it should be understood that one or more of the operations and/or process described herein can be performed manually, e.g., with operator input or instruction, without departing from the spirit or scope of the present disclosure.

Some embodiments involve one or more operations and/or processes that are described herein as being performed automatically, e.g., without requiring operator input or instruction. It should be understood that, in some embodiments, such operations and processes could be performed manually or with some level of operator input or instruction without departing from the spirit or scope of the present disclosure.

Some embodiments involve the use of one or more electronic processing devices, computing devices, and/or control systems. As used herein, the terms “processor” and “computer” and related terms, e.g., “processing device,” “computing device,” “computing system,” and “control system,” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

The disclosed systems and methods are not limited to the specific embodiments described herein. Rather, components of the systems or steps of the methods may be utilized independently and separately from other described components or steps.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A food article cutting and container filling system, comprising:
a food article cutting subassembly including a cutting blade and a body configured to receive a food article, the food article cutting subassembly being rotatable between a first position in which it receives a food article and a second position in which the received food article is cut;
a plunger movable between (a) a retracted position in which the plunger does not extend into the body of the food article cutting subassembly and (b) an extended position in which the plunger extends into the body of the food article cutting subassembly, pushes the food article contained therein across the cutting blade causing the food article to be cut into a plurality of pieces, and pushes the plurality of pieces out from the food article cutting subassembly; and
a container holder configured to receive a container and position the container so as to receive the plurality of pieces from the food article cutting subassembly.

2. The system of claim 1, wherein the food article cutting subassembly is oriented at a first angle with respect to a horizontal plane when in the first position and oriented at a second angle with respect to the horizontal plane when in the second position, wherein the first angle is greater than the second angle.

3. The system of claim 1, wherein the food article cutting assembly is rotatable about a horizontal axis between the first position and the second position.

4. The system of claim 1, comprising:
a chute configured to receive a food article and transfer the food article to the food article cutting subassembly,
wherein the food article cutting subassembly is axially aligned with the chute when in the first position and axially aligned with the plunger when in the second position.

5. The system of claim 1, wherein the plunger is oriented at a first angle with respect to a horizontal plane, the food article cutting subassembly is oriented at the first angle when in the second position, and the container holder holds the container at a second angle with respect to the horizontal plane, the second angle being greater than the first angle.

6. The system of claim 5, wherein the container holder is rotatable between a first position in which it holds the container substantially vertically and a second position in which it holds the container at the second angle.

7. The system of claim 1, wherein the container holder includes a first receptacle and a second receptacle, each of the first and second receptacles being configured to receive a container, and
wherein the container holder is laterally movable between a first position in which the first receptacle is positioned adjacent the food article cutting subassembly and a second position in which the second receptacle is positioned adjacent the food article cutting subassembly.

8. The system of claim 7, wherein the container holder moves from the first position to the second position when a container held within the first receptacle is full.

9. The system of claim 8, wherein the container holder receives a container in the second receptacle when in the second position and while the full container held within the first receptacle is being ejected from the first receptacle.

10. The system of claim 1, comprising:
a container lift and ejection mechanism rotatable in a first direction and a second direction opposite the first direction,
wherein when rotated in the first direction the container lift and ejection mechanism lifts a container held by the container holder and when rotated in the second direction the container lift and ejection mechanism lowers the container and pushes the container held by the container holder out from the container holder.

11. The system of claim 1, comprising:
a container lift/transfer subassembly including a container transfer sled configured to hold at least one container,
wherein the container lift/transfer subassembly is vertically movable and the container transfer sled is horizontally movable, the container transfer sled being configured to transfer a container from a first location to the container holder.

12. The system of claim 11, wherein the container transfer sled includes a centering device and a hook, the centering device being configured to be inserted into and position a container and the hook being configured to grasp the container.

13. A food article cutting and container filling system, comprising:
a food article cutting subassembly including a cutting blade and a body configured to receive a food article;
a plunger movable between (a) a retracted position in which the plunger does not extend into the body of the food article cutting subassembly and (b) an extended position in which the plunger extends into the body of the food article cutting subassembly, pushes the food article contained therein across the cutting blade causing the food article to be cut into a plurality of pieces, and pushes the plurality of pieces out from the food article cutting subassembly;
a container lift/transfer subassembly including a container transfer sled, the container lift/transfer subassembly being vertically movable and the container transfer sled being horizontally movable; and
a container holder configured to receive a container from the container lift/transfer subassembly and position the container so as to receive the plurality of pieces from the food article cutting subassembly,
wherein the container transfer sled picks up the container from a first location and transfers the container from the first location to the container holder by moving horizontally.

14. The system of claim 13, wherein:
the container lift/transfer subassembly moves vertically between a first lowered position and a second raised position,
the container transfer sled moves horizontally between a first forward position and a second rearward position,
the container transfer sled picks up the container from the first location when the container lift/transfer subassembly is in the first lowered position and the container transfer sled is in the first forward position,
the container transfer sled transfers the container from the first location to the container holder by transitioning from the first forward position to the second rearward position, and
the container transfer sled deposits the container on the container holder when the container lift/transfer subassembly is in the first lowered position and the container transfer sled is in the second rearward position.

15. The system of claim 13, wherein the container transfer sled includes a centering device and a hook, the centering device being configured to be inserted into and position a container and the hook being configured to grasp the container.

16. The system of claim 15, wherein the hook is rotatable between a first position in which it does not grasp the container and a second position in which it grasps the container.

17. The system of claim 13, wherein the container lift/transfer subassembly includes a rail and the container transfer sled is slidably mounted to the rail, the container transfer sled being horizontally movable along the rail.

18. The system of claim 17, comprising:
a means for moving the container transfer sled horizontally, the means for moving being mounted to the container lift/transfer subassembly and engaged with the container transfer sled.

19. The system of claim 13, comprising:
a means for moving the container transfer sled horizontally, the means for moving being mounted to the container lift/transfer subassembly and engaged with the container transfer sled.

20. The system of claim 13, comprising:
a pinion gear engaged with the container lift/transfer subassembly by a rotatable shaft; and
a rack mounted to a frame,
wherein the pinion gear engages the rack and moves vertically along the rack to assist in moving the container lift/transfer subassembly vertically.

21. The system of claim 13, wherein the food article cutting subassembly is rotatable about a horizontal axis between a first position in which it receives a food article and a second position in which the received food article is cut.

22. The system of claim 13, wherein the plunger is oriented at a first angle with respect to a horizontal plane, the food article cutting subassembly is oriented at the first angle when in the second position, and the container holder holds the container at a second angle with respect to the horizontal plane, the second angle being greater than the first angle.

23. The system of claim 22, wherein the container holder is rotatable between a first position in which it holds the container substantially vertically and a second position in which it holds the container at the second angle.

24. The system of claim 13, wherein the container holder includes a first receptacle and a second receptacle, each of the first and second receptacles being configured to receive a container, and
wherein the container holder is laterally movable between a first position in which the first receptacle is positioned adjacent the food article cutting subassembly and a second position in which the second receptacle is positioned adjacent the food article cutting subassembly.

25. The system of claim 13, comprising:
a container lift and ejection mechanism rotatable in a first direction and a second direction opposite the first direction,
wherein when rotated in the first direction the container lift and ejection mechanism lifts a container held by the container holder and when rotated in the second direction the container lift and ejection mechanism lowers the container and pushes the container held by the container holder out from the container holder.
